(19) United States
(12) Patent Application Publication
(10) Pub. No.: US 2026/0040168 A1
(43) Pub. Date: Feb. 5, 2026

(54) APPARATUS AND METHODS OF SUBBAND NON-OVERLAPPING FULL DUPLEX (SBFD) CONFIGURATIONS IN LAYER 1 (L1)/LAYER 2 (L2) TRIGGERED MOBILITY (LTM)

(71) Applicant: InterDigital Patent Holdings, Inc., Wilmington, DE (US)

(72) Inventors: Nazli Khan Beigi, Longueuil (CA); Jonghyun Park, Syosset, NY (US); Moon IL Lee, Melville, NY (US); Paul Marinier, Brossard (CA); Aata El Hamss, Laval (CA); Virgile Garcia, Antibes (FR)

(73) Assignee: InterDigital Patent Holdings, Inc., Wilmington, DE (US)

(21) Appl. No.: 18/788,940

(22) Filed: Jul. 30, 2024

(51) Int. Cl. H04W 36/08; H04W 36/00

(52) U.S. Cl. CPC H04W 36/08; H04W 36/0058

(57) ABSTRACT

A source base station transmits configuration information to a wireless transmit/receive unit (WTRU). The WTRU receives the configuration information. The configuration information includes information indicating support for subband non-overlapping full duplex (SBFD) operation. Also, the configuration information includes information for SBFD operation, and information for non-SBFD operation. The base station transmits to the WTRU control information regarding a layer 1 (L1)/layer 2 (L2) triggered mobility (LTM) cell switch. The WTRU receives the control information. The control information further includes cross-link interference (CLI) measurement information. The WTRU then performs an LTM cell switch to a first target base station. Also, the WTRU measures CLI based on the received CLI measurement information. Moreover, if the measured CLI is lower than a first CLI threshold, the WTRU transmits user data to the first target base station using, based on the information for SBFD operation, SBFD operation.

### BACKGROUND

In New Radio (NR), duplex operation may improve conventional time divisional duplex (TDD) operation by enhancing uplink (UL) coverage, improving capacity, reducing latency, and so forth. Conventional TDD is based on splitting the time domain between UL transmission and downlink (DL) transmission in the time domain.

Current research is investigating the feasibility of allowing full duplex, or more specifically, subband non-overlapping full duplex (SBFD), at the base station or gNB within a conventional TDD band. An SBFD configuration in a TDD framework may include a DL slot, a flexible slot, a UL slot and SBFD slots.

### SUMMARY

In an example, a source base station transmits configuration information to a wireless transmit/receive unit (WTRU). The WTRU receives the configuration information. Additionally, the configuration information includes information indicating support for subband non-overlapping full duplex (SBFD) operation. Also, the configuration information includes information for SBFD operation, and information for non-SBFD operation. Further, the base station transmits to the WTRU control information regarding a layer 1 (L1)/layer 2 (L2) triggered mobility (LTM) cell switch. Accordingly, the WTRU receives the control information. The control information further includes cross-link interference (CLI) measurement information. The WTRU then performs an LTM cell switch to a first target base station. Also, the WTRU measures CLI based on the received CLI measurement information. Moreover, if the measured CLI is lower than a first CLI threshold, the WTRU transmits user data to the first target base station using, based on the information for SBFD operation, SBFD operation.

Additionally or alternatively, if the measured CLI is equal to or higher than a first CLI threshold, the WTRU transmits user data to the first target base station using, based on the information for non-SBFD operation, non-SBFD operation. Additionally or alternatively, the information for SBFD operation includes an uplink (UL) grant, a random access (RA) configuration, and one or more physical downlink control channel (PDCCH) monitoring occasions. Further, the SBFD operation applies to SBFD time units. Additionally or alternatively, the information for non-SBFD operation includes a UL grant, an RA configuration, and one or more PDCCH monitoring occasions. Moreover, the non-SBFD operation applies to non-SBFD time units.

Additionally or alternatively, the control information regarding an LTM cell switch further includes indication information to enable SBFD operation. Additionally or alternatively, the user data is transmitted to the target base station using, further based on the indication information to enable SBFD operation, SBFD operation. Additionally or alternatively, the user data is transmitted to the target base station using, further based on a symbol type in which the control information regarding an LTM cell switch is received, SBFD operation.

Additionally or alternatively, the WTRU performs an LTM cell switch to the source base station on a condition that the measured CLI is equal to or higher than a second CLI threshold. Additionally or alternatively, the WTRU performs an LTM cell switch to a second target base station on a condition that the measured CLI is equal to or higher than a third CLI threshold.

Additionally or alternatively, the WTRU reports the measured CLI. Additionally or alternatively, the first CLI threshold is received in at least one of a medium access control (MAC) control element (CE), radio resource control (RRC) signaling, or downlink control information (DCI).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a framework diagram illustrating an example of a subband non-overlapping full duplex (SBFD) configuration in a time divisional duplex (TDD) framework;

FIG. 3 is a control element (CE) diagram illustrating an example of a layer 1 (L1)/layer 2 (L2) triggered mobility (LTM) cell switch triggering command medium access control (MAC)-CE;

FIG. 4 is a CE diagram illustrating an example of new parameters in an LTM cell switch triggering command MAC-CE; and

FIG. 5 is a signaling diagram illustrating an example of an SBFD configuration in LTM.

### DETAILED DESCRIPTION

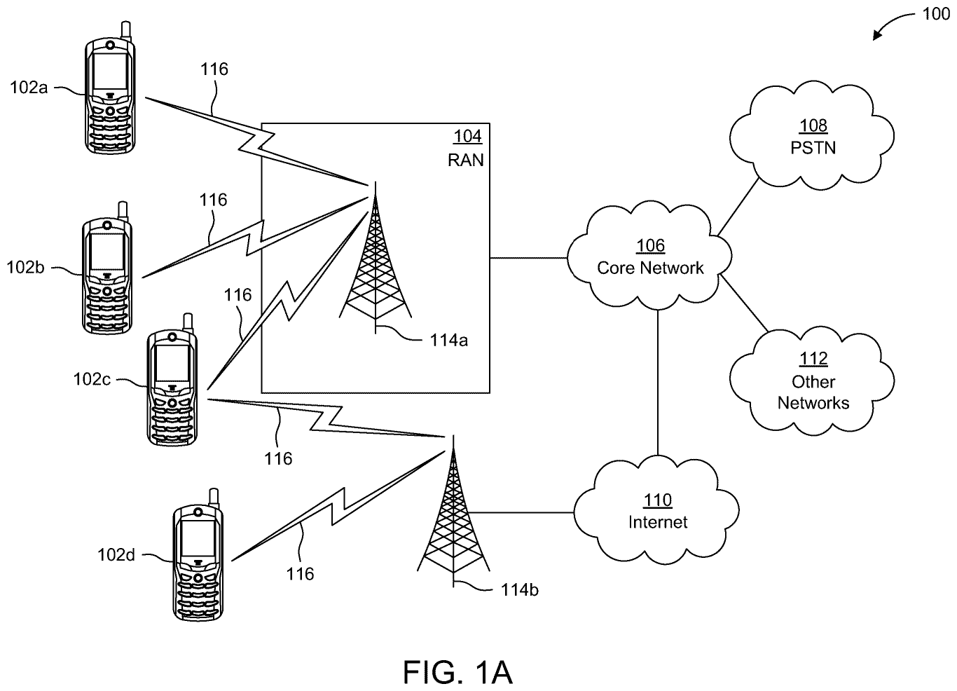

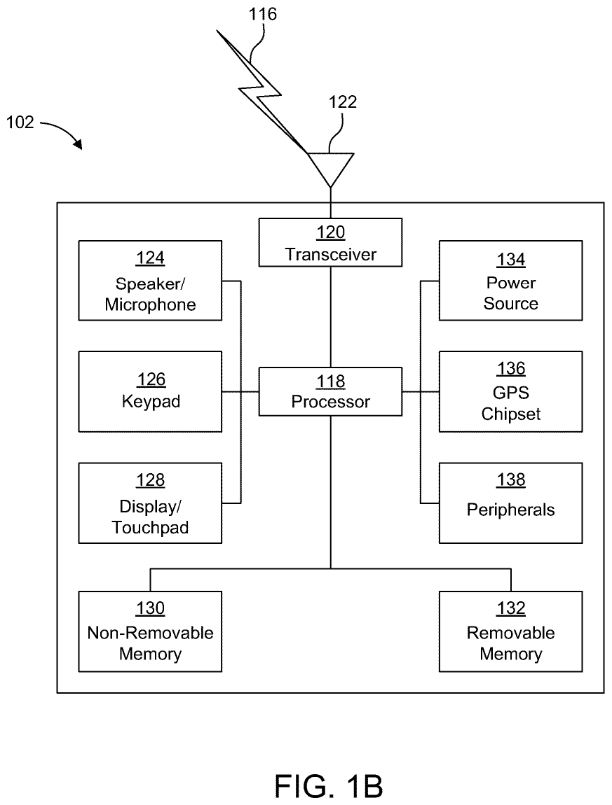

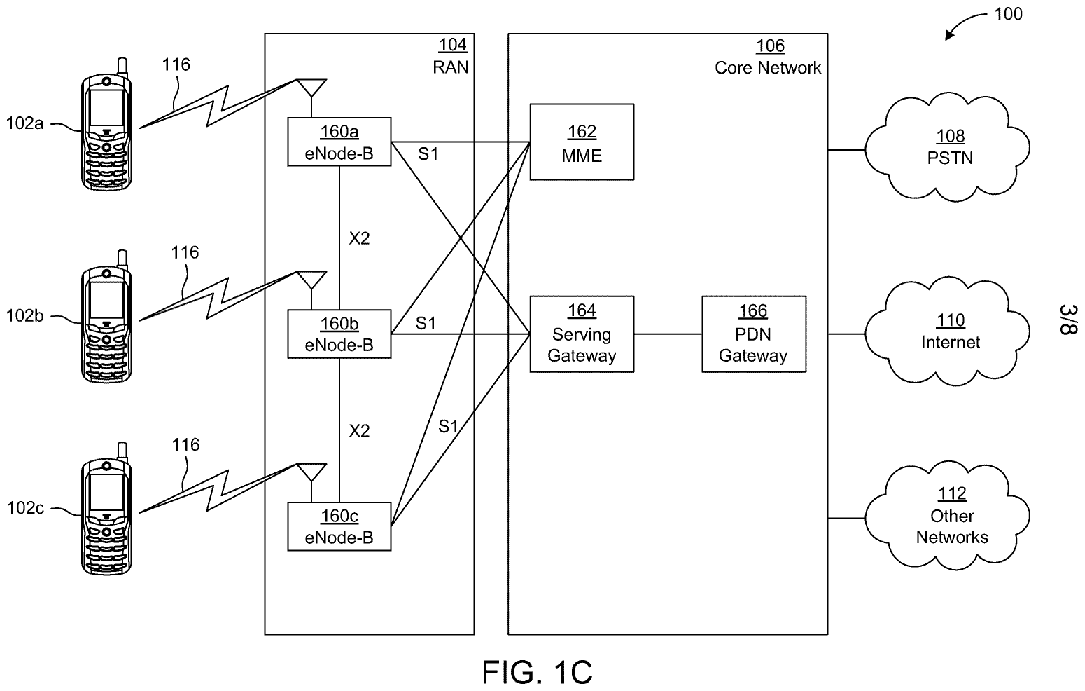

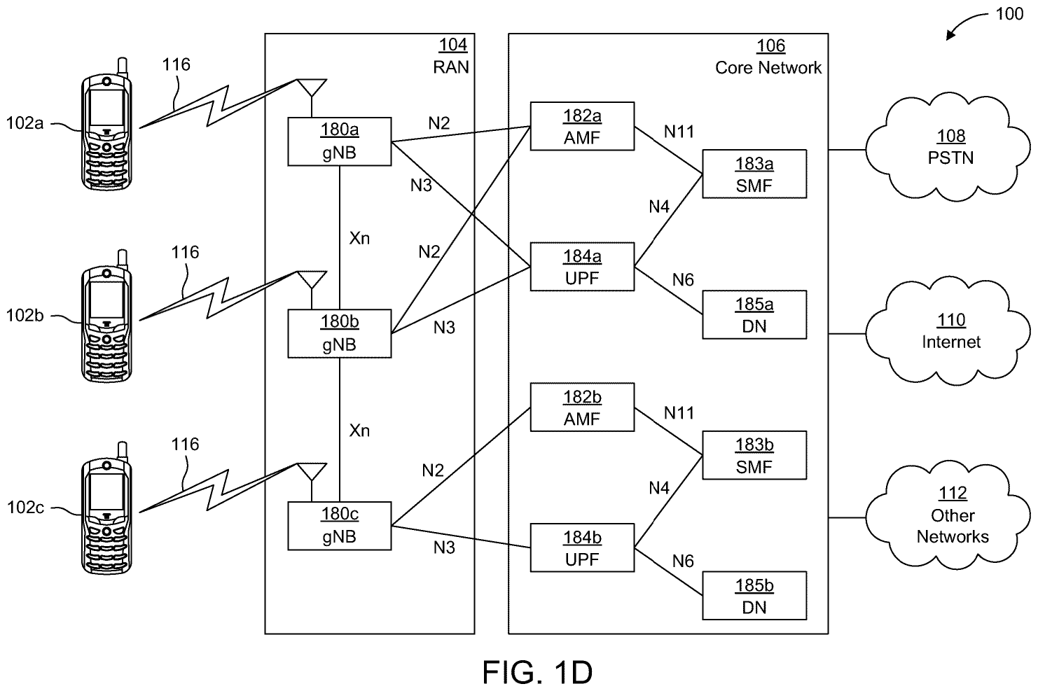

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Conventional time divisional duplex (TDD) is based on splitting the time domain between uplink (UL) transmission and downlink (DL) transmission in the time domain. Current research is investigating the feasibility of allowing full duplex, or more specifically, subband non-overlapping full duplex (SBFD), at the base station or gNB within a conventional TDD band.

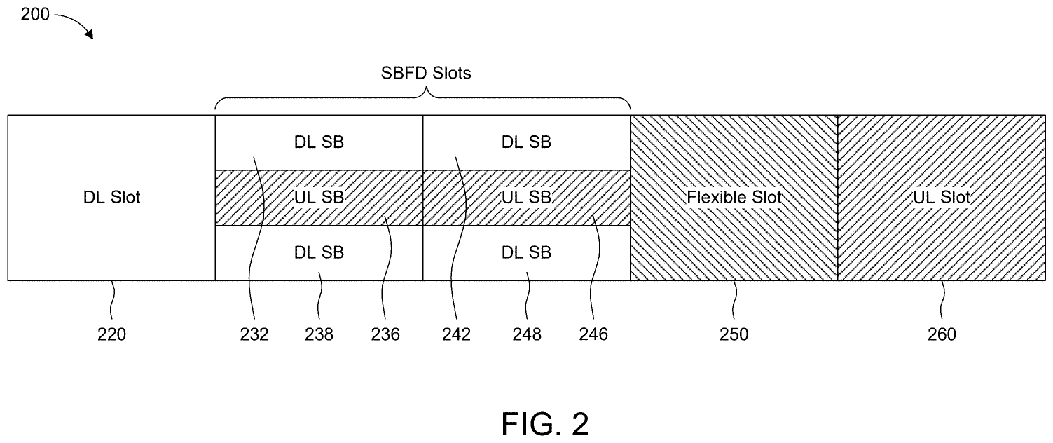

FIG. 2 is a framework diagram illustrating an example of an SBFD configuration in a TDD framework. As shown in an example in framework diagram 200. DL slot 220 may be used for DL transmissions received by a WTRU from a base station. In an example, the WTRU may be the same as or similar to WTRU 102, and the base station may be the same as or similar to base station 114a. Further, UL slot 260 may be used for UL transmissions transmitted by the WTRU to the base station. Additionally or alternatively, flexible slot 250 may not be used, may be used for UL transmissions transmitted by the WTRU to the base station, or may be used for DL transmissions received by a WTRU from a base station.

FIG. 2 also includes two SBFD slots. Specifically, a first slot is divided into subbands in frequency to provide for full duplex operation, with DL subbands of frequency sharing the same time slot as an UL subband. As shown in FIG. 2, DL subbands 232, 238 share the same time slot as UL subband 236. Further, DL subbands 242, 248 share the same time slot as UL subband 246. In this way, the WTRU and base station may use subbands of frequency to obtain full duplex operation, and thereby increase the efficiency of wireless communication.

Layer 1 (L1)/layer 2 (L2) triggered mobility (LTM) is a procedure in which the network decides, and indicates to the WTRU, to change its serving cell based on one or more measurement reports from the WTRU. In LTM, the WTRU receives the LTM cell switch trigger by a command signaled via a MAC control element (CE). The cell switch command indicates an LTM candidate configuration that the network previously prepared and provided to the WTRU through radio resource control (RRC) signaling. Then the WTRU switches to the target configuration according to the cell switch command.

In LTM, both intra-gNB-distributed unit (DU) and intra-gNB-centralized unit (CU) with inter-gNB-DU mobility are supported. LTM further supports intra-frequency and inter-frequency mobility, including mobility to an inter-frequency cell that is not a current serving cell. LTM cell switching is based on two options: random access channel (RACH)-based and RACH-less.

In LTM cell switching, the WTRU reports the measured reference signal received power (RSRP) of the configured and/or indicated non-serving cells. In an example, the RSRP may be an L1 RSRP. Further, the WTRU may report the RSRP to a base station, such as a gNB, in an example. Further, the WTRU may measure the RSRP based on synchronization and signal blocks (SSBs), channel state information-reference signals (CSI-RSs), and the like. Based on the reports on the measured received power, for example, RSRP, the base station or gNB configures LTM and initiates LTM preparations, where the WTRU receives an LTM cell-switch triggering command, for example via MAC-CE.

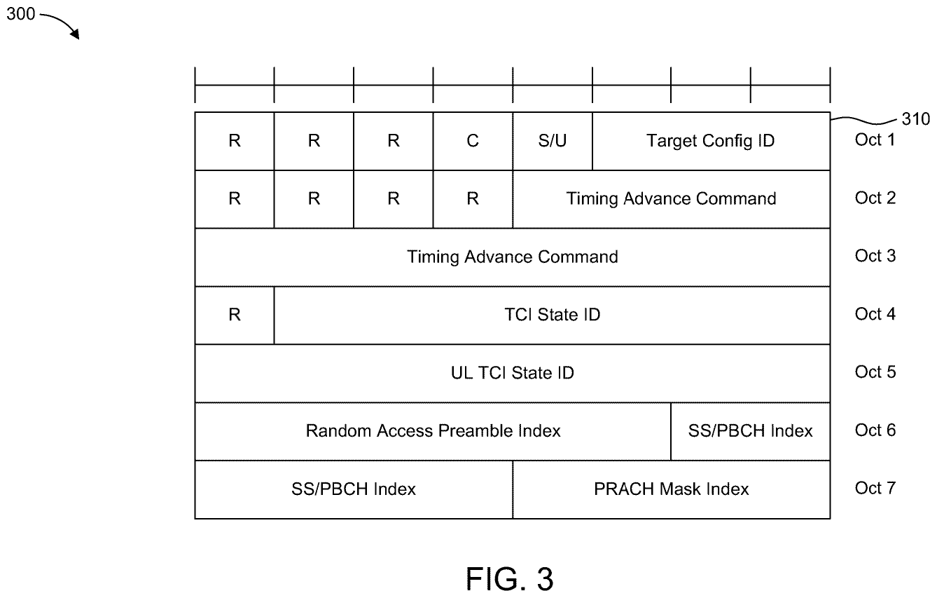

FIG. 3 is a CE diagram illustrating an example of an LTM cell switch triggering command MAC-CE. As shown in an example in CE diagram 300, the LTM cell switch triggering MAC-CE command includes indications on the target cell's configuration identity (ID) 310, timing advance command, some DL and/or UL transmission configuration indicator (TCI) states, and optionally the configurations on contention-free random access (CFRA) such as the physical random-access channel (PRACH) preamble index, SS Block (SSB) index, and PRACH mask index.

In SBFD systems, the WTRU may experience potential effects of cross-link interference (CLI) after switching cells for example, based on the LTM cell switch procedure, which may not be known prior to the cell switch command that may result in reduced link quality performance after cell switch. In example, the cells switch may be between nodes, transmission/reception points (TRPs), base stations, or the like. Accordingly, embodiments and examples herein include improving WTRU behavior to address the problems imposed by strong CLI in the target cell during, and after, an LTM cell switch. Addressing these problems increases the efficiency of wireless communication.

Embodiments and examples provided herein include methods of LTM cell switch based on measured CLI. Specifically, in an LTM cell switch example, the SBFD-capable WTRU receives indications from a base station or gNB on whether to operate based on SBFD resources, configurations, and the like, after the LTM cell switch in the target cell. The WTRU receives configurations for measuring and reporting CLI in the target cell as part of LTM cell switch and after switching to the target cell. Further, the WTRU is indicated to switch back to the previous serving cell or switch to another candidate cell if the measured CLI in the target cell is higher than corresponding thresholds.

For example, the WTRU sends a MeasurementReport message to a gNB. Further, the gNB configures LTM and initiates LTM preparation. Additionally or alternatively, the WTRU may be in an RRC_CONNECTED state.

The WTRU receives an RRCReconfiguration message including one or more sets of configuration information regarding LTM candidate cells, including as in the followings examples. In an example, the WTRU may include up to 8 set of configuration information, and the configuration information may be sent via RRC signaling. Further, the configuration information may include an indication regarding whether the candidate cell supports SBFD or not.

Also, if a candidate cell supports SBFD, the WTRU receives two sets of configurations regarding SBFD and non-SBFD configured UL grants, Random Access configurations, physical downlink control channel (PDCCH) monitoring occasions, and the like. The two sets of configuration may be separate sets of configurations.

Moreover, if a candidate cell supports SBFD, the WTRU receives configurations of the time and frequency of SBFD resources, DL and UL subbands (e.g., indicated based on number of resource elements (REs), resource blocks (RBs), etc.), guard bands (e.g., indicated based on number of REs, RBs, etc.), and the like. The configurations of the DL and UL SBs, as well as the guard bands, may be provided in terms of RBs and the like. Further, if the configurations of SBFD time and frequency resources are absent, the WTRU implicitly determines that the SBFD configuration for the corresponding candidate cell is the same as the SBFD configurations in the serving cell.

In addition, if the gNB or base station decides to perform cell switch to a target cell, WTRU receives information triggering a cell switch. For example, if the gNB or base station decides to perform cell switch to a target cell, WTRU receives an LTM cell switch command MAC-CE triggering cell switch. In another example, if the gNB or base station decides to perform cell switch to a target cell, WTRU receives a cell switch command via RRC signaling. Additionally or alternatively, if the gNB or base station decides to perform cell switch to a target cell, WTRU receives a cell switch command via downlink control information (DCI).

Further, the WTRU determines if the WTRU is enabled to operate based on SBFD resources and/or configurations in the target cell, after cell switching, based on one an explicit indication, based on an implicit indication, or based on both, as in the following. In an explicit indication example, the WTRU receives a flag indication to enable/disable operation (e.g., Tx/Rx) based on SBFD resources, configurations, and the like via an LTM cell switch triggering MAC-CE.

In another example, the WTRU may receive the flag indication via RRC signaling. Additionally or alternatively, the WTRU may receive the flag indication via DCI.

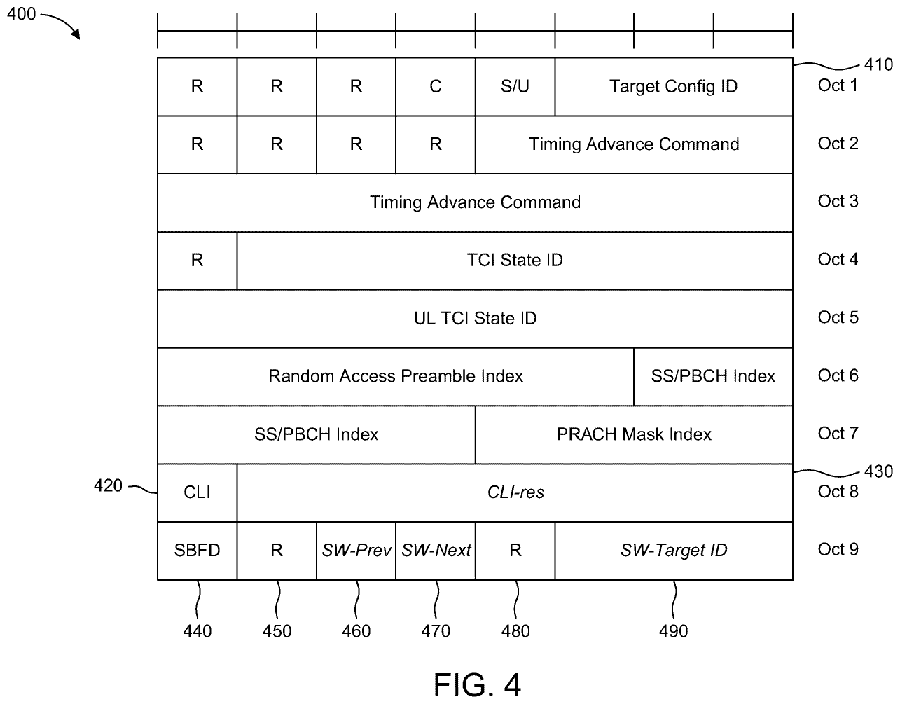

FIG. 4 is a CE diagram illustrating an example of new parameters in an LTM cell switch triggering command MAC-CE. As shown in an example in CE diagram 400, the flag indication is shown as parameter SBFD 440.

In an implicit indication example, the WTRU determines if the WTRU is enabled to use SBFD resources and/or configurations in the target cell based on the symbol type of the symbol in which the LTM cell switch triggering MAC-CE is received. For example, if the LTM cell switch triggering MAC-CE is received in SBFD symbols, the WTRU determines that WTRU is enabled to perform based on SBFD resources and/or configurations in the target cell. Otherwise, in LTM cell switch triggering MAC-CE is received in non-SBFD symbols, WTRU determines that WTRU is not enabled to perform based on SBFD resources and/or configurations in the target cell. In an example, the SBFD symbols would be within one or more of DL SBs 232, 238, 242, 246 of FIG. 2.

Further, the WTRU performs cell switching CLI screening and clearance. For example, the WTRU performs CLI measurement after cell switch. As part of the triggering command, the WTRU may receive one or more indications regarding L1-CLI measurements in the target cell and after cell switch. In examples, the triggering command may be received in a MAC-CE, in RRC signaling or in DCI, as noted above. Examples of one or more indications regarding L1-CLI measurements are provided in the following.

In an example, the WTRU may receive an indication to enable/disable L1-CLI measurement based on the target cell and after the LTM cell switch. For example, the indication may be a flag indication. In an example, the indication to enable/disable L1-CLI measurement is shown as parameter CLI 420 in FIG. 4.

Additionally or alternatively, the WTRU may receive a CLI measurement and reporting resource indication including sounding reference signal (SRS) index, time, and frequency resources for CLI measurement, a UL grant for reporting the measured CLI, and the like. Additionally or alternatively, the CLI measurement and reporting resource indication could include one or more configuration IDs to indicate the CLI measurement and reporting configurations that the gNB or base station previously prepared and provided to the WTRU through RRC signaling. In an example, the CLI measurement and reporting resource indication is shown as parameter CLI-res 430.

Also, the WTRU may enter a mode of operation after CLI measurement in the target cell. As part of triggering command, the WTRU receives indications on the next steps after measuring the CLI. Further, the WTRU's mode of operation may be based on one or more (pre) configured thresholds. In examples, the triggering examples, the triggering command may be received in one or more of a MAC-CE, RRC signaling or DCI. Further, the one or more thresholds may be configured or preconfigured in one or more of a MAC-CE, RRC signaling or DCI.

In an example, if measured CLI is lower than a first threshold, the WTRU may use SBFD operation or may enter a mode of SBFD operation. For example, the WTRU is enabled to operate based on SBFD resources and/or configurations in the target cell in case the post-switching measured CLI in the target cell is lower than a first CLI threshold.

Otherwise, if measured CLI is higher than the first CLI threshold, the alternatives include one or more of the following: non-SBFD operation, switching back to the previous serving cell, or switching to a second target cell.

For example, if measured CLI is higher than the first CLI threshold, the WTRU may enter non-SBFD operation. Specifically, the WTRU determines to operate based on non-SBFD operation in case the measured CLI after cell switch in the target cell is higher than the first CLI threshold.

Additionally or alternatively, if measured CLI is higher than the first CLI threshold, the WTRU may switch back to the previous serving cell. Specifically, the WTRU is enabled to switch to the previous serving cell, in case the measured CLI in the target cell is higher than a second CLI threshold and the measured RSRP, before switching, in the previous serving cell is higher than a first RSRP threshold. The WTRU may be enabled to switch to the previous serving cell via a parameter. In example, the parameter may be received in a MAC-CE, in RRC signaling or in DCI. For example, the parameter may be the parameter SW-Prev 460. In a further example, the second CLI threshold may be the same as or higher than the first CLI threshold.

Additionally or alternatively, if measured CLI is higher than the first CLI threshold, the WTRU may switch to a second target cell. Specifically, the WTRU is enabled to switch to another target cell, indicated by a second target configuration ID, in case the measured CLI in the target cell is higher than a third CLI threshold, and the measured RSRP in the second target cell is higher than a second RSRP threshold.

The WTRU may be enabled to switch to another target cell via a parameter, which may be received in a MAC-CE, in RRC signaling or in DCI. For example, the parameter to enable the WRU to switch to another target cell may be parameter SW-Next 470.

Further, the second target configuration ID may be a parameter, which may be received in a MAC-CE, in RRC signaling or in DCI. For example, the second target configuration ID parameter may be SW-Target ID 490.

Additionally or alternatively, the third CLI threshold may be the same as or higher than the first and the second CLI thresholds. Additionally or alternatively, the second RSRP threshold may be the same as or different from the first RSRP threshold.

Additionally or alternatively, Target Config ID 410 may be the same as or similar to Target Config ID 310. Further, R 450 and R 480, in Octet 9, may be reserved for other use or future use.

Additionally or alternatively, after the WTRU has already performed L1-CLI measurements on the target cell, based on the indicated configs and selected the mode of operation based on the measured CLI after cell switch in the target cell. Further, the may report the measured CLI based on the configured reporting resources, for example, configured UL grant, scheduling request (SR) and the like. If SBFD or non-SBFD operation is selected, the WTRU may perform Rx/Tx based on SBFD and non-SBFD resources and/or configurations in the target cell.

Additionally or alternatively, if switching back is selected, the WTRU sends an SR or a configured UL grant to the serving cell to indicate the switching back. Additionally or alternatively, if switching to the second target cell is selected, the WTRU sends and indication to the second target cell to indicate the switching, via an SR or a configured UL grant, or the WTRU transmits PRACH to the second target cell, in case of RACH-less or RACH-based cell switching, respectively.

As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example.’ A symbol ‘/’ (e.g., forward slash) may be used herein to represent ‘and/or’, where for example, ‘A/B’ may imply ‘A and/or B.’

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a synchronization signal (SS) block. The WTRU transmission may be referred to as “target,” and the received RS or SS block may be referred to as “reference” or “source.” In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit physical uplink shared channel (PUSCH) and demodulation-reference signal (DM-RS) of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a physical uplink control channel (PUCCH). Such spatial relation may also be referred to as a “beam indication.”

The WTRU may receive a first (target) downlink channel or signal according to the same spatial domain filter or spatial reception parameter as a second (reference) downlink channel or signal. For example, such association may exist between a physical channel such as PDCCH or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a TCI state. A WTRU may be indicated an association between a CSI-RS or SS block and a DM-RS by an index to a set of TCI states configured by RRC and/or signaled by MAC CE. Such indication may also be referred to as a “beam indication.”

As used herein, a TRP may be interchangeably used with one or more of transmission point (TP), reception point (RP), radio remote head (RRH), distributed antenna (DA), base station (BS), a sector (of a BS), and a cell (e.g., a geographical cell area served by a BS), but still consistent with the embodiments and examples provided herein. Hereafter, Multi-TRP may be interchangeably used with one or more of MTRP, M-TRP, and multiple TRPs, but still consistent with this embodiments and examples provided herein.

As used herein, the term “subband” and/or “sub-band” may to refer to a frequency-domain resource and may be characterized by at least one of the following: a set of RBs; a set of RB sets, for example, when a carrier has intra-cell guard bands; a set of interlaced resource blocks; a bandwidth part, or portion thereof; or a carrier, or portion thereof.

For example, a subband may be characterized by a starting RB and number of RBs for a set of contiguous RBs within a bandwidth part. A subband may also be defined by the value of a frequency-domain resource allocation field and bandwidth part index.

As used herein, the term “XDD” is used to refer to a subband-wise duplex (e.g., either UL or DL being used per subband) and may be characterized by at least one of the following: Cross Division Duplex (e.g., subband-wise frequency division duplexing (FDD) within a TDD band); SBFD; Subband-based full duplex (e.g., full duplex as both UL and DL are used/mixed on a symbol/slot, but either UL or DL being used per subband on the symbol/slot); Frequency-domain multiplexing (FDM) of DL/UL transmissions within a TDD spectrum; a full duplex other than a same-frequency (e.g., spectrum sharing, subband-wise-overlapped) full duplex; or an advanced duplex method, e.g., other than (pure) TDD or FDD.

As used herein, the term “dynamic (/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier (CC) or a bandwidth part (BWP) may have one single type among ‘D’, ‘U’, and ‘F’ on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB or base station (e.g., cell, TRP) employing dynamic/flexible TDD may transmit a downlink signal to a first WTRU being communicated/associated with the first gNB or base station based on a first SFI and/or tdd-UL-DL-config configured/indicated by the first gNB or base station, and a second gNB or base station (e.g., cell, TRP) employing dynamic/flexible TDD may receive an uplink signal transmitted from a second WTRU being communicated/associated with the second gNB or base station based on a second SFI and/or tdd-UL-DL-config configured/indicated by the second gNB or base station. In an example, the first WTRU may determine that the reception of the downlink signal is being interfered by the uplink signal, where the interference caused by the uplink signal may refer to a WTRU-to-WTRU CLI.

A WTRU may be during at least one of the one or more RRC states and/or RRC modes, for example including RRC-Connected state, RRC-Inactive state, and/or RRC-Idle state. A WTRU may be in an RRC-Connected state, during which the WTRU may have connected, established RRC context, and/or have at least one RRC connection, for example, to one or more cells, base stations, gNBs or base stations, TRPs, and the like. In RRC-Connected state, the WTRU may receive RRC context and/or one or more configuration information at least including one or more radio bearers, logical channels, PDU sessions, security information, etc. During RRC-Connected state, the connected WTRU may measure one or more RSRP, reference signal received quality (RSRQ), received signal strength indicator (RSSI), and the like based on one or more received, detected, configured, and/or indicated reference signals (RSs) received from serving cell and/or one or more neighboring cells. The connected WTRU may report the measured parameters, for example to the serving cell.

As used herein, downlink reception may be used interchangeably with Rx occasion, PDCCH, PDSCH, SSB reception, but still consistent with the embodiments and examples provided herein. Hereafter, uplink transmission may be used interchangeably with Tx occasion, PUCCH, PUSCH, PRACH, SRS transmission, but still consistent with the embodiments and examples provided herein. Herein, time instance, slot, symbol, and subframe may be used interchangeably, but still consistent with the embodiments and examples provided herein. Herein, UL-only and DL-only Tx/Rx occasions may interchangeably be used with legacy TDD UL or legacy TDD DL, respectively, and still consistent with the embodiments and examples provided herein. In an example, the legacy TDD UL transmission or legacy DL reception occasions are the cases where SBFD is not configured and/or where SBFD is disabled. Hereinafter, the terms received signal power, received signal energy, received signal strength, SSB energy per resource element (EPRE), CSI EPRE, RSRP, RSSI, signal-to-interference-plus-noise ratio (SINR), RSRQ, SS-RSRP, SS-RSSI, SS-SINR, SS-RSRQ, CSI-RSRP, CSI-RSSI, CSI-SINR, and CSI-RSRQ may be used interchangeably, but still consistent with the embodiments and examples provided herein.

Herein, the term CLI may be used interchangeably with interference, and still consistent with the embodiments and examples provided herein. Herein, the term non-SBFD may be used interchangeably with operation without SBFD, TDD, legacy TDD, and still consistent with the embodiments and examples provided herein. Herein, the terms ‘paired spectrum’ and FDD may be used interchangeably, but still consistent with the embodiments and examples provided herein. Herein, the terms ‘unpaired spectrum’ and TDD may be used interchangeably, but still consistent with the embodiments and examples provided herein.

Herein, the phrases “WTRU is configured,” “WTRU is indicated,” “WTRU receives configuration,” and so forth, may imply that the configuration is indicated, for example, via RRC, MAC-CE, DCI, master information block (MIB), system information block (SIB), and so forth, unless indicated otherwise. For example, “WTRU is configured” may imply “WTRU is configured via RRC, MAC-CE, MIB, SIB, and so forth.”

A WTRU may be configured with one or more types of slots within a bandwidth, wherein a first type of slot may be used or determined for a first direction (e.g., downlink); a second type of slot may be used or determined for a second direction (e.g., uplink); a third type of slot may have a first group of frequency resources within the bandwidth for a first direction and a second group of frequency resources within the bandwidth for a second direction.

As used herein, bandwidth may be interchangeably used with bandwidth part (BWP), carrier, subband, and system bandwidth; the first type of slot (e.g., the slot for a first direction) may be referred to as downlink slot; the second type of slot (e.g., slot for a second direction) may be referred to as uplink slot; the third type of slot may be referred to as an SBFD slot; the group of frequency resource for a first direction may be referred to as downlink subband, downlink frequency resource, or downlink RBs; the group of frequency resource for a second direction may be referred to as uplink subband, uplink frequency resource, or uplink RBs; the group of frequency resource for a flexible direction (e.g., that can be configured for a first direction, second direction, etc.) may be referred to as flexible subband, flexible frequency resource, or flexible RBs; and the group of frequency resource between a first direction and a second direction may be referred to as guard band, guard frequency resource, or guard RBs.

In an example, a (SBFD-enabled) WTRU may receive or be configured with one or more SBFD UL or DL subbands in one or more DL, UL, and/or flexible TDD time instances (e.g., symbols, slots, frames, and so forth). The WTRU may be configured with one or more resource allocations for SBFD subbands.

For example, the SBFD configuration may include a flag signal (e.g., enabled/disabled), where for example a first value (e.g., zero (0)) indicates a first mode of operation (e.g., based on SBFD resources and/or configurations), and a second value (e.g., one (1) may indicate a second mode of operation (e.g., based on non-SBFD resources and/or configurations). The modes of operation (e.g., SBFD or non-SBFD) may be indicated via, for example MIB, SIB, RRC, MAC-CE, DCI, and so forth.

Herein, the term “WTRU operating based on SBFD operation” may indicate WTRU performing Tx/Rx based on SBFD resources and/or configurations. Herein, the term “WTRU operating based on non-SBFD operation” may indicate WTRU performing Tx/Rx based on non-SBFD resources and/or configurations.

The WTRU may receive the time resources (e.g., one or more symbols, slots, and so forth), for which the first mode of operation (e.g., SBFD) is defined in for example one or more BWPs, subbands, CCs, cells, and so forth. The WTRU may receive the frequency resources (e.g., subbands, BWPs, etc. including one or more physical resource blocks (PRBs)) within (active and/or linked) BWP, for which the first mode of operation (e.g., SBFD) is configured. The time instances (e.g., slots, symbols) may be indicated based on periodic, semi-persistent, or aperiodic configurations. In an example, the time instances may be indicated via a bitmap configuration, where each bit corresponds to a time instance (e.g., slot, symbol, subframe, etc.) and each bit indication indicates whether corresponding time instance can be used for the first or second mode of operation.

In an example, a WTRU may be configured with a DL TDD configuration for a CC or a BWP for one or more Rx occasions (e.g., via tdd-UL-DL-config-common, dedicated configurations, SFI, and so forth). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a CC or a BWP for one or more Tx occasions (e.g., via tdd-UL-DL-config-common, dedicated configurations, SFI, and so forth). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a CC or a BWP for one or more Rx/Tx occasions (e.g., via tdd-UL-DL-config-common, dedicated configurations, SFI, and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL) may be indicated via a flag indication, where for example a first value (e.g., zero (0) may indicate a first direction (e.g., UL duplexing mode), and a second the value (e.g., one (1)) may indicate a second direction (e.g., DL duplexing model). The duplexing mode configuration and/or flag for the first mode of operation (e.g., SBFD) may be configured as part of modes of operation configuration, for example via MIB, SIB, RRC, DCI, MAC-CE, and the like. The duplexing mode configuration and/or flag for the first mode of operation (e.g., SBFD) may be configured as part of resource allocation configuration for a Tx/Rx occasion.

In an example, the WTRU may be configured with DUD configuration, where an UL subband is configured between two DL subbands, as seen in FIG. 2. In another example, the WTRU may be configured with UD configuration, where an UL subband is configured with higher frequencies followed by a DL subband with lower frequencies. In another example, the WTRU may be configured with DU configuration, where a DL subband is configured with higher frequencies followed by au UL subband with lower frequencies. These examples are non-limiting examples of the SBFD configurations and parameters that may be included in SBFD configurations. One or more of those configurations may be included. Other configurations may be included.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. subbands in the frequency domain, throughout the BWP, for the duration of the first slot. However, in the second slot with the second type (non-SBFD), the WTRU may be configured with only one direction type, for example DL, UL, flexible, and the like, in the frequency domain, throughout the BWP, for the duration of the second slot.

In an example, if the WTRU is configured with a second slot with UL direction, this may indicate legacy TDD UL slot, UL-only slot, and/or non-SBFD UL slot. In another example, if the WTRU is configured with a third slot with second type (non-SBFD) with DL direction, this may indicate legacy TDD DL slot, DL-only slot, and/or non-SBFD DL slot. In another example, if the WTRU is configured with a fourth slot with second type (non-SBFD) with flexible direction, this may indicate legacy TDD flexible slot and/or non-SBFD flexible slot, and so forth.

A WTRU may be configured, determined, or indicated to perform a measurement of CLI RSSI in a given time period, wherein the given time period may be one or more slots, OFDM symbols, resource blocks (RBs), and/or REs. The CLI-RSSI which may be measured in a given time and/or frequency resource may be referred to as L1-CLI-RSSI, short-term CLI-RSSI, aperiodic CLI-RSSI, and so forth. Alternatively, the WTRU may be configured, determined, or indicated to perform a measurement of Reference Signal Received Power (RSRP) based on one or more reference signals (e.g., SRS-RSRP) in the context of CLI measurement in a given time period, wherein the given time period may be one or more slots, OFDM symbols, RBs, and/or REs. The SRS-RSRP which may be measured in a given time and frequency resource may be referred to as L1-SRS-RSRP, short-term SRS-RSRP, aperiodic SRS-RSRP, SRS-RSRP-CLI, and so forth.

Herein the terms CLI-RSSI, L1-CLI-RSSI, and RSSI may be interchangeably used but still consistent with the embodiments and examples provided herein. Herein, the terms SRS-RSRP, SRS-RSRP-CLI, L1-SRS-RSRP, and RSRP may be interchangeably used but still consistent with the embodiments and examples provided herein.

Examples of L1/L2 CLI measurement are provided herein. One or more RSSI (or RSRP) types may be used and a WTRU may be configured to perform one or more RSSI (or RSRP) types, wherein a first RSSI (or RSRP) type may be based on a measurement over a long time period (e.g., more than one slot) and the measurement is reported via a higher layer signaling (e.g., RRC, MAC); and a second RSSI (or RSRP) type may be based on a measurement over a short time period (e.g., one slot, within a slot, one or more OFDM symbols within a slot) and the measurement is reported via a L1 signaling (e.g., PUCCH, PUSCH, RACH, SRS). RSSI may be interchangeably used with RSRP, RSRQ, and SINR. CLI-RSSI may be interchangeably used with SRS-RSRP and SINR.

The WTRU may be configured with a set of time and frequency resources to measure L1-CLI-RSSI, wherein the time and frequency resources for L1-CLI-RSSI measurement may be referred to as CLI-RSSI Measurement Resource (CRMR). CRMR may be a resource configured, determined, or defined (e.g., via RRC, MAC-CE, DCI) (e.g., via CLI-ResourceConfig, CLI-ResourceConfig-r-16, and so forth) with one or more of following properties.

The properties may include a set of muted REs in downlink resource (e.g., PDSCH), wherein the muted REs may be rate-matched around or punctured for downlink reception and/or uplink transmission. The set of muted REs may have a same pattern (e.g., same time and frequency location) in each RB. The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power resources (e.g., CSI-RS and/or zero power (ZP)-CSI-RS).

The properties may include a set of REs not scheduled or used for the WTRU measuring CRMR. The properties may include a set of REs may be located in an RB which may be configured or determined as guard band (or guard RB). A guard band (or guard RB) may be located in between uplink and downlink resources. A WTRU may skip receiving or transmitting a signal in guard band.

The properties may include a one or more reference signals (e.g., DMRS, SRS, sidelink CSI-RS, etc.). Also, the properties may include a second set of DMRS REs within a second code division multiplexing (CDM) group (e.g., within a scheduled downlink resource and/or RBs, e.g., of PDSCH), where a WTRU may receive a DCI, scheduling the PDSCH, indicating a first set of DMRS REs corresponding to a first CDM group to be used for receiving the PDSCH. In an example, the WTRU may receive the DCI, scheduling the PDSCH, indicating a first set of DMRS REs corresponding to a first CDM group, based on an indicated ‘(DMRS) antenna port’ field of the DCI. In response to receiving the DCI, the WTRU may determine that a second set of DMRS REs within a second CDM group (other than the first CDM group) may be used as the CRMR (e.g., within the scheduled PDSCH). The properties may be located within a scheduled resource (e.g., scheduled PDSCH RBs).

CRMR may be configured commonly for a set of WTRUs (e.g., WTRUs in proximity). For example, a gNB or base station may configure a CRMR for a group of WTRUs, wherein the group of WTRUs may share one or more of following: A group-ID to receive a DCI (e.g., a group-RNTI); A zone-ID, wherein the zone-ID may be determined based on a geographical location of the WTRU (e.g., GNSS); or WTRUs paired for sidelink unicast (or groupcast) transmission. L1-CLI-RSSI measurement (including CRMR resource) may be considered as CSI reporting quantity and configured as a part of CSI reporting setting.

CRMR may be configured in a first subband type (e.g., DL subbands) to measure the (effect of) one or more reference signals received in a second subband type (e.g., UL subbands). As such, the reference signals may be received and measured in resources that can be identified as zero-power or muted resources. The WTRU may be configured, determined, or indicated to measure the effect of reference signals being transmitted in other resources (e.g., second type resources, e.g., UL subbands) in these resources (e.g., first type resources, e.g., DL subbands). For example, a first WTRU may be configured to measure SRS-RSRP in DL subbands on an SBFD configuration, where the SRS is transmitted by a second WTRU in the UL subbands. In an example, the first WTRU may measure SRS-RSRP based of the configured SRS signaling in the DL subbands. In another example, the WTRU may measure the CLI-RSSI based on the configured SRS signaling in the UL subbands.

Examples provided herein include delta-CLI measurement. The WTRU may be configured, determined, or indicated to perform a delta CLI-RSSI, which may be based on a first CLI-RSSI measurement in a first time and/or frequency location and a second CLI-RSSI measurement in a second time and/or frequency location. One or more of following may apply.

The delta CLI-RSSI (delta-CLI-RSSI) may be a difference between a first CLI-RSSI (e.g., CLI-RSSI1) and a second CLI-RSSI (e.g., CLI-RSSI2), e.g., delta-CLI-RSSI=CLI-RSSI1-CL-RSSI2 (or delta-CLI-RSSI=CLI-RSSI2-CL-RSSI1, etc.). The first CLI-RSSI may be measured from CRMR resources located in the edge of the scheduled RBs while the second CLI-RSSI may be measured from CRMR resources located in the middle of the scheduled RBs.

A WTRU may be configured with a first CRMR resource for the first CLI-RSSI measurement and a second CRMR resource for the second CLI-RSSI measurement. A WTRU may determine to report CLI measurement related information when a measured delta-CLI-RSSI is larger than a threshold. For example, CLI reporting may be triggered based on delta-CLI-RSSI measurement is larger than a threshold, wherein the threshold may be predetermined or configured.

Examples provided herein include a bandwidth, a subband configuration for CLI measurement, or both. The WTRU may be configured or determine to measure CLI-RSSI per subband level. For example, a subband may be configured, or predetermined and a WTRU may perform CLI-RSSI measurement in each subband. One or more of following may apply.

Subband size may be determined based on the number of scheduled RBs (e.g., for PDSCH). The WTRU may report CLI-RSSI measurement for all subbands. The WTRU may report a subset of CLI-RSSI, wherein the subset may be determined based on one or more conditions (e.g., CLI-RSSI value above threshold, subband location (e.g., edge of scheduled RBs), and/or subband index).

The WTRU may determine a bandwidth of beam measurement and/or reporting (e.g., wideband or subband) based on one or more of following conditions: time unit type or presence of CLI-RSSI measurement. A time unit type may be SBFD or non-SBFD, in an example. For example, a WTRU may report wideband CRI (e.g., wideband beam index) in non-SBFD time units (e.g., symbol, slot, and so forth) and the WTRU may report subband CRI (e.g., subband beam index) in SBFD time units. In an example where the one or more conditions are or include a presence of CLI-RSSI measurement, the bandwidth of beam measurement/reporting is determined based on whether CLI-RSSI is measured in the same slot or not.

The WTRU may be indicated to perform CLI-RSSI measurement in a specific frequency location within a scheduled RBs (or non-scheduled RBs), wherein the specific frequency location may be one or more of subbands, RBs, and REs. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and each CRMR resource may be located in a specific frequency location based on configuration. The WTRU may be indicated to perform measurement on CRMR resource indicated in a DCI.

Examples provided herein include SRS types. The WTRU may be configured or indicated to transmit one or more SRSs, where an SRS resource of the one or more SRSs may be configured for a particular purpose of at least one of: beam management, channel acquisition (e.g., based on channel reciprocity), link adaptation, antenna switching, and so forth. The mentioned particular purpose may be interpreted to be for a communication link between the WTRU and a gNB or base station (e.g., its serving gNB or base station, cell, TRP, or a target cell, gNB or base station, TRP during cell switching, etc.), which may be denoted by a first SRS type. The first SRS type is a non-limiting example of a type of SRS that may be used for or to support a communication link between the WTRU and its serving cell, TRP, gNB and/or base station.

The WTRU may be configured or indicated to transmit second one or more SRS resources at least for CLI measurement purpose at a receiver side, which may be denoted by a second SRS type (e.g., CLI-SRS). The second SRS type is a non-limiting example of a type of SRS that may be used for or to support at least the CLI measurements at a receiver side (e.g., other WTRU(s), gNB(s) or base station(s), other communication device and/or node in the network). Any other type of transmission may be substituted for the transmission based on the second SRS type and still be consistent with the embodiments and examples provided herein. The CLI measurements at the receiver side (e.g., a second WTRU) may comprise at least one of: an energy-level or power-level measurement (e.g., CLI-RSSI) on a configured or indicated DL resource (e.g., a form of zero-power resource, a configured CLI-measurement resource, and/or the like); a sequence-based and/or correlation-based RS power measurement (e.g., SRS-RSRP) on a configured or indicated RS sequence and/or resource (e.g., SRS resource which may be transmitted from the WTRU causing the CLI to the second WTRU); an SINR or channel quality indicator (CQI) type of channel quality metric derivation to be reported; and the like.

Examples provided herein include cell-level mobility. A WTRU may determine, identify, receive, be configured, and/or indicated to perform cell switch from its serving cell to a determined, identified, configured, and/or indicated target cell. In an example, the WTRU may be in an RRC-Connected state. During the RRC-Connected state, the mobility of the WTRU may be handled and/or controlled by the network (NW). During the RRC-Connected state, the connected WTRU may perform one or more radio resource management (RRM) measurements and report the RRM measurements, for example to its serving cell. The connected WTRU may receive a request, command, and/or indication to switch from the serving cell to a target and/or candidate neighboring cell.

A WTRU may receive, be configured, and/or indicated with a handover (HO) command from a serving cell, where the (intra-NR) RAN handover preparation and execution may be performed based on one or more message exchanges, for example between gNBs or base stations. For example, the WTRU may determine, be configured, and/or indicated to reset the MAC entity and re-establish radio link control (RLC), and the like, during handover mechanism triggered by RRC. In an example, during HO preparation, the source and target gNBs or base stations may establish in-between user-plane (U-plane) tunnels. In another example, during HO execution, user data may be forwarded from source gNB or base station to the target gNB or base station. In another example, the data forwarding from the source gNB or base station may continue until UPF or the source gNB or base station's buffer is emptied.

A WTRU may receive, be configured, and/or indicated with a conditional handover (CHO) command from a serving cell, wherein the WTRU may perform the configured and/or indicated CHO when one or more configured and/or indicated handover execution conditions are met. In an example, the WTRU may receive the HO conditions via RRC, where the WTRU may evaluate the configured and/or indicated execution conditions upon receiving the CHO configurations. For example, the WTRU may stop evaluating the conditions when the HO is accomplished. For example, the WTRU may receive CHO configurations that may be generated by serving and/or source cell in addition to CHO configurations that may be generated by candidate and/or neighboring cells. In an example, a CHO condition may include one or more trigger conditions, for example, based on one or more measured RSRP, RSRQ, RSSI, SINR, etc. In case the WTRU determines that one or more of the CHO conditions for a candidate and/or target cell are satisfied, the WTRU may initiate HO to the corresponding target cell. In an example, the data forwarding between the source and target gNBs or base stations may be accomplished before or after HO execution, which may be addressed as early or late data forwarding, respectively.

A WTRU may receive, be configured, and/or indicated to perform LTM cell switch to a candidate and/or target cell. For example, the WTRU may receive, identify, be configured, and/or indicated to send (L1) (RRM) measurement reports, for example to a gNB or base station, where the gNB or base station may change WTRU's serving cell to a target and/or candidate cell, via an LTM cell switch command, for example signaled by MAC-CE signaling, RRC signal or DCI. As part of the cell switch command, the WTRU may receive an indication to an LTM candidate (pre) configuration, for example regarding an LTM target cell, where the WTRU may have received the (pre) configured configuration information, for example via semi-static configurations, e.g., via RRC. As such, the WTRU may switch to the configured and/or indicated LTM target cell based on the received LTM cell switch command.

A WTRU may be configured and/or indicated to initiate UL timing advance (TA) acquisition before LTM cell switching procedure, as in preparation phase. In an example, the WTRU may be indicated to send a PRACH to one or more candidate cells, where the WTRU may receive the indication, for example by a PDCCH order. As such, the WTRU may receive the TA command as part of LTM cell switch command, as in examples in FIG. 3 or FIG. 4. In another example, the WTRU may be configured and/or indicated to measure TA.

Depending on the availability of a valid TA value, a WTRU may perform either a RACH-less LTM or RACH-based LTM cell switch. In case the WTRU is provided with a valid TA value, for example in the cell switch command, the WTRU may apply the indicated TA value. In the case where WTRU-based TA measurement is configured and the WTRU is not provided with a valid TA value in the cell switch command, the WTRU may apply the valid TA value by itself. Therefore, the WTRU may perform RACH-less LTM cell switch upon receiving the cell switch command. If no valid TA value is available, the WTRU may perform RACH-based LTM cell switch toward the indicated target cell, where the WTRU may transmit the PRACH preamble indicated in LTM cell switch command, based on the indicated SSB index and PRACH Mask index as in examples in FIG. 3 or FIG. 4.

In RACH-less LTM, a WTRU may access a target cell using one or more configured and/or dynamic grants. For example, the WTRU may be (pre) configured with the configured grant (e.g., including corresponding time-domain resource allocations (TDRA), frequency-domain resource allocations (FDRA), etc.), for example via the LTM candidate configuration, e.g., via RRC. In an example, the WTRU may select the configured grant occasion associated with the beam indicated in the cell switch command. For example, the beam may be indicated by the UL and/or DL TCI states in the cell switch command, as in examples in FIG. 3 or FIG. 4). In an example, after an LTM cell switch to the target cell, the WTRU may start monitoring PDCCH on the target cell for dynamic scheduling.

In an example, a WTRU performing an LTM cell switch mechanism, for example triggered by a MAC-CE, may reset the MAC entity, where the RLC and packet data convergence protocol (PDCP) handling may be configured, for example, via RRC configuration. Additionally or alternatively, the RLC and PDCP handling may be configured by DCI or by another MAC-CE.

Examples of conditional LTM are provided herein. A WTRU may receive, be configured, and/or indicated with a conditional LTM cell switch command from a serving cell, wherein the WTRU may perform the configured and/or indicated conditional LTM cell switch when one or more configured and/or indicated LTM cell switch conditions are met. In an example, the WTRU may receive the conditional LTM cell switch conditions via RRC signaling, where the WTRU may evaluate the configured and/or indicated execution conditions upon receiving the conditional LTM cell switch configurations. For example, the WTRU may stop evaluating the conditions when the LTM cell switch is accomplished. For example, the WTRU may receive conditional LTM cell switch configurations that may be generated by a serving cell and/or source cell in addition to conditional LTM cell switch configurations that may be generated by one or more candidate cells and/or neighboring cells. In an example, a conditional LTM cell switch condition may include one or more trigger conditions, for example, based on one or more measured RSRP, RSRQ, RSSI, SINR, and the like. In case the WTRU determines that one or more of the conditional LTM cell switch conditions for a candidate and/or target cell are satisfied, the WTRU may initiate LTM cell switch to the corresponding target cell. In an example, the data forwarding between the source and target gNBs or base stations may be accomplished before or after LTM cell switch, which may be addressed as early or late data forwarding, respectively.

As used herein, the term “LTM cell switch” may interchangeably be used with HO, CHO, and conditional LTM cell switch, but still consistent with the embodiments and examples provided herein.

Examples of SBFD operation in LTM cell switching are provided herein. Further, SBFD configurations in cell switch procedure are provided in examples herein. In a full duplex (e.g., SBFD) system, the potential effect of CLI should also be considered in LTM cell switch procedure. That is, the WTRU needs to report the CLI in the target cell as part of the procedure. If measured CLI in the target cell is not reported and if the measured CLI is not available at the serving and/or target cells, the LTM cell switch may only be configured to be based on non-SBFD symbols, that is, for example UL transmission on UL-only symbols. However, not using SBFD symbols after LTM cell switching could degrade the latency, capacity, coverage, etc. for the (e.g., SBFD-capable) WTRU that has switched its cell. On the other hand, if WTRU continues to operate based on SBFD operation after LTM cell switch to the target cell, without measuring and reporting potential CLI in the target cell, this might result in increased block error rate (BLER) and degraded performance, due to potentially lower SINR (e.g., due to potential CLI).

The benefit in reporting CLI in the target cell as part of LTM cell switching is that the WTRU could have a potentially seamless operation during and after LTM cell switch, while avoiding unnecessary latency, degraded performance, and the like.

Examples are provided herein of candidate cell's configuration information for cell switching. A WTRU may receive, identify, be configured, and/or indicated to send (L1) (RRM) measurement reports, for example to a gNB or base station, where the gNB or base station may change configure and initiate switching WTRU's serving cell to a target and/or candidate cell, based on the reported measurements. The WTRU may receive one or more configuration information on one or more candidate cells. For example, the WTRU may receive the configuration information on the candidate cells, for example via RRC signaling. In an example, the WTRU may receive configuration information for LTM cell switching. For example, the WTRU may receive configuration information for a (pre) configured maximum number of (e.g., eight) candidate cells. In an example, the WTRU may receive configuration information for each configured candidate cell, for example including one or more of the following: candidate cell ID, candidate cell physical cell identity (PCI), candidate cell RRC configuration, TCI states, NZP CSI-RS resource(s) and/or resource set(s), SSB Configuration, early UL synchronization configuration, WTRU-base TA measurement, L2 reset indication, and so forth.

In a candidate cell ID example, the WTRU may receive configured candidate cell's index, identification, and the like. Further, in a candidate cell PCI example, the WTRU may receive configured candidate cell's PCI. In a candidate cell RRC configuration example, the WTRU may receive one or more RRC configurations corresponding to the candidate cell, e.g., via Itm-CandidateConfig.

In a TCI states example, the WTRU may receive one or more TCI states for LTM cell switch to the corresponding candidate cell, where the configured TCI states may consist of UL, DL, and/or joint UL and DL TCI states. In an NZP CSI-RS resource(s) and/or resource set(s), the WTRU may receive configuration information on one or more NZP CSI-RS resources and/or NZP CSI-RS resource sets associated with the corresponding candidate cell for LTM cell switch.

In an SSB configuration example, the WTRU may receive one or more configuration information on the SSB associated with the candidate cell based on which the WTRU may perform RRM measurements for the corresponding candidate cell. In an example, the configuration on the SSB may include the frequency of the SSBs, SSB burst's periodicity, time domain position of the transmitted SSBs in an SSB burst (e.g., via ssb-PositionsInBurst), SSBs' subcarrier spacing, SSB's secondary SS EPRE, and the like. In an early UL synchronization configuration example, the WTRU may receive configuration information for performing early UL synchronization and TA acquisition, e.g., via Itm-EarlyUL-SyncConfig. In an example, the WTRU may be configured to perform early UL synchronization for the UL and/or supplementary UL.

In a WTRU-based TA measurement example, the WTRU may receive indication on whether to perform WTRU-based TA measurements towards the corresponding candidate cell for LTM cell switch, e.g., via Itm-WTRU-MeasuredTA-ID. In an L2 reset indication example, the WTRU may receive an indication on whether L2 reset should be performed when an LTM cell switch procedure is triggered towards an LTM candidate cell., e.g., via Itm-NoResetID.

Examples are provided herein of SBFD configurations for candidate cells. In an example solution, a WTRU may receive one or more configuration information regarding one or more candidate cells, wherein the configuration information may include indications and/or configuration on a first mode of operation. In an example, the first mode of operation may be based on FD (e.g., SBFD) resources and/or configurations. For example, the WTRU may receive the SBFD configuration information on the candidate cells via RRC signaling. In an example, the WTRU may receive SBFD configurations for the candidate cells with regards to HO, CHO, LTM cell switch, and/or conditional LTM cell switch. In an example, the WTRU may receive SBFD configuration information for each configured candidate cell, for example including one or more of the following: support of the first mode of operation, one or more time/frequency configurations, quality and/or interference measurement occasions, thresholds and/or offset values, resource configurations, and so forth.

In support of the first mode of operation (e.g., FD, SBFD, subband-overlapping FD, inband-FD) example, the WTRU may receive an indication (e.g., flag indication) on whether the corresponding candidate cell supports SBFD operation, resources, and/or configurations. In a time/frequency configurations example, the WTRU may receive one or more configuration information regarding the resource configuration for the first mode of operation (e.g., SBFD) in the corresponding candidate cell. The configuration information may include time resources (e.g., symbols, slots, frames, etc.), frequency resources (e.g., CC, BWP, subbands, RBs, etc.), periodicity (e.g., symbols, slots, frames, etc.), and the like, where the first mode of operation is configured.

In a quality and/or interference measurement occasions example, the WTRU may be configured with a set of CLI measurement occasions for measuring CLI in the target cell. In an example, each configured set may include one or more of CLI measurement resources, CLI measurement type (e.g., CLI-RSSI, CLI-RSRP, etc.), CLI measurement configurations, CLI measurement beam direction (e.g., TCI state, e.g., for directional CLI measurement), periodicity for CLI measurement, starting time and/or time duration for CLI measurement, UL grant for reporting the measured CLI, and the like for example, one or more of the following may apply: CLI-RSSI measurement occasions, CLI-RSRP measurement occasions, and so forth.

In a CLI-RSSI measurement occasions example, the WTRU may be configured with one or more time and frequency resources for measuring CLI-RSSI in the target cell. In an example, a first CLI-RSSI measurement occasion may be configured in UL subbands in one or more time instances, for example configured as SBFD resources, a second CLI-RSSI measurement occasion may be configured in DL subbands in one or more time instances, for example configured as SBFD resources, and so forth.

In a CLI-RSRP measurement occasions example, the WTRU may be configured with one or more time and frequency resources for measuring CLI-RSRP in the target cell in addition to corresponding reference signal (RS) to be used for measurements. In an example, the WTRU may be configured to measure SRS-RSRP, where the WTRU may be configured with one or more SRS-RSRP measurement occasions in UL subbands in one or more time instances, for example configured as SBFD resources. Moreover, the WTRU may be configured with the SRS index to be measured in the configured SRS-RSRP measurement occasions. In another example, the WTRU may be configured to measure CLI-RSRP based on one or more other RSs (e.g., another WTRU's UL or DL DM-RS, e.g., PUSCH/PUCCH and/or PDCCH/PDSCH DM-RS transmitted from or to another WTRU, respectively) to measure CLI-RSRP in UL or DL subbands. As such, the WTRU may receive time and frequency resources in addition to the RS to be used to measure CLI-RSRP.

In a thresholds and/or offset values example, the WTRU may be configured with one or more threshold values, for example for CLI measurement. In an example, the WTRU may be configured with one or more thresholds for measured CLI-RSSI, CLI-RSRP, SRS-RSRP, and the like. In another example, the WTRU may be configured with one or more offset values to be used for CLI measurement. For example, the WTRU may be configured with a time offset value based on which the WTRU may determine the time window to measure CLI, for example SRS-RSRP. In another example, the WTRU may be configured with a frequency offset value based on which the WTRU may determine the frequency (e.g., RBs) to measure CLI, for example based on one or more UL or DL subbands' edges (e.g., in SBFD resources), boundaries, and/or one or more frequency starting points. In another example, the WTRU may be configured with an offset value to determine a new threshold value based on a (pre) configured threshold value, for example for comparing with the measured CLI.

In an example, the resource configurations may also include (e.g., SBFD) UL/DL order (e.g., DUD, UDU, DU, UD, etc.), DL subbands (e.g., number of RBs), UL subbands (e.g., number of RBs), guard bands (e.g., number of RBs), and the like.

Examples are provided herein of a second set of configurations for operation based on first mode of operation (e.g., SBFD) in the target cell. In an example solution, in case a candidate cell supports a first mode of operation, a WTRU may determine and/or receive a second set of configurations for operation in the first mode of operation. The WTRU may receive the second set of configurations in addition to the first received set of configurations for operation in a second mode of operation in the corresponding candidate cell. In an example, the first mode of operation may be based on WTRU performing Tx/Rx based on resources and/or configurations configured for the first mode of operation (e.g., SBFD), where the second mode of operation may be based on WTRU performing Tx/Rx based on resources and/or configurations configured for the second mode of operation (e.g., non-SBFD). For example, the WTRU may receive the configuration information on the candidate cells through signaling via RRC, MAC-CE, DCI, etc. In an example, a cell supporting the first mode of operation (e.g., SBFD) may indicate the cell supporting resources and/or configurations for the first mode of operation (e.g., SBFD).

In an example, the WTRU may receive two separate sets of configurations for Tx/Rx based on first and second modes of operations (e.g., to be used in SBFD and non-SBFD resources), for example including time and frequency resources, UL power, thresholds, etc., as described herein. For example, the WTRU may receive a first set of RA configurations for Tx/Rx in time instances configured as the first mode of operation (e.g., SBFD) and a second set of RA configurations for Tx/Rx in time instances configured as the second mode of operation (e.g., non-SBFD). In another example, the WTRU may receive one or more offset values, thresholds, and/or configurations as part of the second set of configurations to be used along with and based on the first set of configurations. For example, one or more of the following configurations may apply: RA configurations, UL or DL frequency resources, UL power, and so forth.

For example, the WTRU may determine RA resources for Tx/Rx operation in time instances configured for the first mode of operation (e.g., SBFD) using one or more determined, received, configured, and/or indicated time and/or frequency offset values based on the first configured and/or indicated RA occasions in time instances and/or resources configured for the second mode of operation (e.g., non-SBFD).

For example, the WTRU may determine one or more UL (e.g., PUSCH) frequency resources, for example frequency hopping resources, in time instances and/or resources configured for the first mode of operation (e.g., SBFD) based on configured frequency resources in time instances and/or resources configured for the second mode of operation (e.g., non-SBFD) along with one or more frequency offset values.

For example, the WTRU may determine one or more power parameters, for example UL power, maximum UL power, PHR, etc., for UL transmission in UL subbands in time instances configured for the first mode of operation (e.g., SBFD) based on respective parameters configured in resources and/or time instances configured for the second mode of operation (e.g., non-SBFD) along with one or more power offset values, and the like.

For example, a WTRU may not be allowed and/or disabled to operate based on SBFD resources, and/or the WTRU may determine to not operate based on SBFD operation, resources, and/or configurations. In this case, the WTRU may operate, for example based on legacy TDD operation, to perform Tx/Rx based on configured DL-only or UL-only resources and/or time instances. That is the WTRU may not use SBFD configurations and/or resources on UL and/or DL subbands in SBFD time instances.

In another example, the WTRU may determine, be allowed, and/or enabled to operate based on SBFD operation, where the WTRU may use SBFD configurations and resources, including UL and/or DL subbands in SBFD time instances. Moreover, the WTRU that is enabled, allowed, and/or determined to use SBFD resources, may also use DL-only and/or UL-only time instances in addition to the configured SBFD resources. For example, the WTRU may use the configured SBFD configurations, for example on time and frequency resources, when using configured SBFD time and frequency resources. In another example, the WTRU may use the configured non-SBFD configurations, for example on time and frequency resources, when using time and frequency resources that are not configured as SBFD resources.

In an example, the WTRU may determine, receive, be configured, and/or indicated with one or more of the following (e.g., SBFD and non-SBFD) configurations: configured UL grant, PDCCH monitoring occasions, random access (RA) configurations, and so forth.

In a configured UL grant example, the WTRU may receive a first and a second set of configuration information for configured UL grant in the target cell. In an example, the received first and second configurations may include a first and second sets of time and frequency resources, respectively, for one or more configured UL grants. For example, the first set of time and frequency resources may be configured for the first mode of operation (e.g., SBFD) and the second set of time and frequency resources may be configured for the second mode of operation (e.g., non-SBFD). For example, the WTRU may use the first set of configured UL grant if the WTRU determines, is enable, allowed, configured, and/or indicated to operate based on resources, configurations, etc. configured for the first mode of operation (e.g., SBFD) in the target cell, for example after (LTM) cell switch. In another example, the WTRU may use the second set of configured UL grant if the WTRU determines, is configured, and/or indicated to operate based on resources, configurations, etc. configured for the second mode of operation (e.g., non-SBFD) in the target cell, for example after (LTM) cell switch.

In a PDCCH monitoring occasions example, the WTRU may receive a first and a second set of configuration information for PDCCH monitoring occasions in the target cell. In an example, the received first and second configurations may include a first and second sets of time and frequency resources, respectively. For example, the first set of time and frequency resources may be configured for the first mode of operation (e.g., SBFD) and the second set of time and frequency resources may be configured for the second mode of operation (e.g., non-SBFD). For example, the WTRU may use the first set of PDCCH monitoring occasions if the WTRU determines, is allowed, enabled, configured, and/or indicated to operate based on resources, configurations, etc. configured for the first mode of operation (e.g., SBFD) in the target cell, for example after (LTM) cell switch. In another example, the WTRU may use the second set of PDCCH monitoring occasions if the WTRU determines, is configured, and/or indicated to operate based on resources, configurations, etc. configured for the second mode of operation (e.g., non-SBFD) in the target cell, for example after (LTM) cell switch.

In an RA configurations example, the WTRU may receive a first and a second set of RA configuration information in the target cell. In an example, the received first and second configurations may include a first and second sets of time and frequency resources for RACH occasions, preamble types, PRACH power configurations, SSB-to-RO mapping configurations, RACH Mask index, PRACH length, etc. For example, the first set of RA configurations may be configured to be used for the first mode of operation (e.g., SBFD) and the second set of RA configurations may be configured for the second mode of operation (e.g., non-SBFD). For example, the WTRU may use the first set of RA configurations if the WTRU determines, is allowed, enabled, configured, and/or indicated to operate based on resources, configurations, etc. that are configured for the first mode of operation (e.g., SBFD) in the target cell, for example after (LTM) cell switch. In another example, the WTRU may use the second set of RA configurations if the WTRU determines, is configured, and/or indicated to operate based on resources, configurations, etc. that are configured for the second mode of operation (e.g., non-SBFD) in the target cell, for example after (LTM) cell switch.

In an example solution, in case one or more of the configuration information in a candidate cell is absent, a WTRU may determine that the corresponding configurations in the candidate cell may be similar to (e.g., the same for at least one configuration parameter regarding SBFD as) the configured and/or indicated settings, parameters, and/or configurations in the serving cell. For example, the WTRU may use the same configured and/or indicated configuration information in the serving cell to be applied in a target cell, if the corresponding configuration information is absent in the configured configurations for the corresponding target cell. For example, if one or more configurations (e.g., on SBFD resources and/or configurations) for a target cell is absent in the configured and/or indicated configurations, the WTRU may use the configured and/or indicated configurations (e.g., for SBFD resources and/or configurations) in the serving cell to be applied in the target cell. For example, if frequency (and/or time) location information of at least one SBFD subband (e.g., UL subband, DL subband, flexible subband (which subband type to be determined later), guardband, etc.) for a target cell is absent in the configured and/or indicated configurations, the WTRU may use the same frequency (and/or time) location information of the at least one SBFD subband configured and/or indicated in the (e.g., the current) serving cell to be applied in the target cell.

Examples are provided herein of CLI measurement after a cell switch procedure. Further, enabled/disabled first mode of operation (e.g., SBFD) in the target cell after LTM Cell Switch/HO examples are provided herein.

A WTRU may determine and/or receive a configuration and/or an indication, for example via RRC, MAC-CE, DCI, and the like, to switch to a configured and/or indicated target cell. For example, the WTRU may be in an RRC Connected state. In an example, the WTRU may receive an LTM cell switching command via MAC-CE signaling. The cell switching indication command may include indications on the target cell ID, TA command, CFRA configurations, and the like.

In an example solution, a WTRU may determine, be configured, and/or indicated if the WTRU is allowed and/or enabled to operate based on a first mode of operation in the target cell and after cell switch to the target cell, based on one or more indications and/or configurations. For example, the WTRU may determine, be configured, and/or indicated if the WTRU is enabled or disabled to operate based on resources, configurations, etc. configured for the first mode of operation (e.g., SBFD) in the target cell and after cell switch to the target cell, based on one or more indications and/or configurations.

In an example, the WTRU may determine if the WTRU is allowed and/or enabled to operate based on a first or a second mode of operation in the target cell and after switching to the target cell, where the first mode of operation may be based on SBFD resources, configurations, and the like, and the second mode of operation may be based on non-SBFD resources, configurations, and the like.

For example, the WTRU may determine if the first mode of operation is enabled or disabled based on one or more of the following: explicit indications and/or configurations, or an implicit indication. In explicit indications and/or configurations examples, the WTRU may receive the indication if the first mode of operation in the target cell and after cell switch is enabled or disabled, via one or more explicit indications. In an example, the WTRU may receive a flag indication where a first value (e.g., value one) may indicate that the first mode of operation (e.g., using SBFD resources and/or configurations) is enabled and a second value (e.g., value zero) may indicate that the first mode of operation is disabled. For example, in case the indication indicates that the first mode of operation is disabled, the WTRU may operate based of a second mode of operation (e.g., using non-SBFD resources and/or configurations). The WTRU may receive the explicit indication based on one or more of the following example indications: semi-static configuration, dynamic configurations, and so forth.

In a semi-static configurations example, the WTRU may be enabled and/or allowed based on received, configured, indicated, and/or determined (pre) configurations to operate based on the first mode of operation after cell switching to a target cell. In an example, the WTRU may receive the (pre) configurations based on (e.g., semi-static) configurations and/or indications received as part of candidate and/or target cell's configurations. For example, the WTRU may receive the configuration and/or indication via RRC signaling. In an example, the WTRU may receive the indication on whether the first mode of operation is enabled, as part of candidate cell configurations in LTM cell switch, conditional LTM cell switch, HO, CHO, and so forth, per configured candidate cell.

In a dynamic indication example, the WTRU may receive dynamic indication on whether the first mode of operation is enabled after cell switching to a target cell. For example, the WTRU may receive the configuration and/or indication via LTM and/or conditional LTM cell switching triggering command to the corresponding target cell, for example via MAC-CE (e.g., parameter SBFD 440 in FIG. 4). In another example, the WTRU may receive the configuration and/or indication via DCI, for example for conditional LTM cell switching or CHO.

In an implicit indication example solution, a WTRU may implicitly determine if the first mode of operation in the target cell and after cell switch is enabled based on a type of time instance (e.g., slot, symbol, time unit, frame, etc.), e.g., where the LTM cell switch MAC-CE command may be received. For example, in case the WTRU receives the LTM cell switch MAC-CE command in time instance with a first type (e.g., SBFD symbol, slot, frame, etc.), the WTRU may determine that the first mode of operation (e.g., SBFD) is enabled. As such, the WTRU may use the first configured set of candidate cell configurations in the target cell and after cell switch. For example, the WTRU may use the first configured UL grant, first configured PDCCH monitoring occasion, and/or first configured random access configuration, etc., that is associated with the target cell, e.g., that is indicated via MAC-CE LTM cell switch command, to be applied after cell switch to the target cell. In another example, in case the WTRU receives the LTM cell switch MAC-CE command in time instance with a second type (e.g., non-SBFD), the WTRU may determine that the first mode of operation is not enabled and/or allowed for the WTRU in the target cell. As such, the WTRU may use the second configured set of candidate cell configurations in the target cell and after cell switch. For example, the WTRU may use the second configured UL grant, second configured PDCCH monitoring occasion, and/or second configured random-access configuration, etc., that is associated with the target cell, e.g., that is indicated via MAC-CE LTM cell switch command, to be applied after cell switch to the target cell.

Examples provided herein include post cell switching CLI screening and clearance. In an example solution, a WTRU that has determined, is configured, and/or indicated to be enabled and/or allowed to operate based on a first mode of operation after cell switch and/or HO to a target cell may determine, be configured, and/or indicated to measure CLI in the target cell after cell switch and/or HO is executed. For example, the WTRU may receive configuration and/or indications as part of configurations and procedures for LTM cell switch, conditional LTM cell switch, HO, CHO, etc. In an example, the first mode of operation may be based on configured SBFD resources, configurations, etc. In an example, the WTRU may determine, be configured, and/or indicated to measure L1-CLI, subband-wise CLI, differential CLI, delta CLI, frequency-selective CLI, and so forth, as described herein. In another example, the WTRU may determine, be configured, and/or indicated to measure and report L1-CLI-RSSI, L1-SRS-RSRP, L1-CLI-RSRP, and the like.

In an example, the WTRU may determine, be configured, and/or indicated to measure post cell switching CLI, in case the WTRU is enabled and/or allowed to operate based on first mode of operation, that is for example using SBFD resources, configurations, etc. in the target cell and after cell switching. For example, the WTRU may receive one or more configuration information and/or indications on performing post cell switching CLI screening and measurement. In an example, the WTRU may receive the configurations and/or indications via RRC, MAC-CE, DCI, etc. For example, the WTRU may receive one or more indications as part of LTM cell switching MAC-CE command. The WTRU may receive one or more of the following example indications: enable/disable post cell switching CLI measurement, a resource indication for CLI measurement, and so forth.

In an enable/disable post cell switching CLI measurement example, the WTRU may receive a (e.g., flag) indication to enable or disable CLI measurement in the target cell and after LTM, conditional LTM, HO, and/or CHO cell switching. For example, the CLI measurement may be based on L1-CLI measurement. As an example, see parameter CLI 420 as a flag indication, for example in MAC-CE LTM cell switch triggering command in FIG. 4.

In a resource indication for CLI measurement example, the WTRU may receive a configuration ID (e.g., index) that may indicate the CLI measurement and reporting configurations that may be based on (previously) (pre) configured, prepared, and/or provided configurations and indications, e.g., through RRC signaling. As an example, see parameter CLI-res 430 as configuration ID, for example in MAC-CE LTM cell switch triggering command in FIG. 4. In an example, the configuration ID may indicate a (pre) configured set of configurations, including for example CLI measurement and reporting resources such as corresponding RS index, time and frequency resources for CLI measurement, CLI measurement type (e.g., LCI-RSSI, SRS-RSRP, etc.), UL grant for reporting the measured CLI, and the like, as described herein.

In an example solution, in case a WTRU is configured and/or indicated to perform post switching CLI measurement in the target cell, the WTRU may determine that data forwarding between the cells may be based on late data forwarding. For example, the data forwarding may be due to WTRU performing LTM cell switch, conditional LTM cell switch, HO, and/or CHO. In an example, the WTRU may implicitly determine to expect the data forwarding is based on late data forwarding if the WTRU is configured and/or indicated to perform post switching CLI measurement in the target cell. That is, the WTRU may determine that the data forwarding may be performed after CLI measurement and reporting in the target cell. For example, the WTRU may receive the configuration to perform post switching CLI measurement in the target cell via RRC signaling. In another example, the WTRU may receive the indication to perform post switching CLI measurement in the target cell, for example via parameter CLI 420, in the MAC-CE LTM cell switch triggering command, see FIG. 4.

In an example, the WTRU may measure CLI based on one or more configured and/or indicated configurations and settings in the target cell and after cell switching. For example, the WTRU may measure CLI-RSSI, CLI-RSRP, SRS-RSRP, etc. In an example, the WTRU may report the measured CLI in the configured and/or indicated UL resources to the target cell. In another example, the WTRU may report an indication (e.g., a flag indication) indicating whether the measured CLI is higher and/or lower than a configured and/or indicated corresponding threshold. The WTRU may be (pre) configured with corresponding threshold values for measured CLI, for example via RRC, MAC-CE, DCI, and the like.

In an example, the transmitted report may include the SRS index (SRI), the CLI measurement time and frequency resources and potential time and/or frequency offset values, the UL or DL beam direction, the UL or DL TCI state, etc. based on which the WTRU may have performed the CLI measurement.

Examples are provided herein of a mode of operation based on post cell switching CLI measurement. In an example solution, a WTRU may determine the mode of operation in the target cell, after cell switching, based on one or more configurations, indications, and/or measured quality parameters and/or interference values. For example, the WTRU may determine the mode of operation in the target cell based on one or more measured CLI values in the target cell, after cell switching. For example, the WTRU may determine the mode of operation in the target cell based on measured CLI that the WTRU may have measured after cell switch to the target cell. The WTRU may determine the mode of operation based on the post cell switching CLI measurement in addition to one or more (pre) configured indications, configuration, and/or one or more determined, indicated, and/or configured threshold values. For example, the WTRU may receive an indication to enable post cell switching CLI measurement as part of part of MAC-CE indication, see parameter CLI 420 as a flag indication, for example in the MAC-CE LTM cell switch triggering command in FIG. 4.

In an example, the WTRU may determine the mode of operation based on one or more L1-CLI measurements, for example including L1-CLI-RSSI, L1-CLI-RSRP, L1-SRS-RSRP, etc. For example, the WTRU may receive the indications, configurations, threshold values, and so forth via RRC, MAC-CE, DCI, etc. For example, the WTRU may receive configuration, indications, and/or thresholds as part of configurations and procedures for LTM cell switch, conditional LTM cell switch, HO, CHO, etc. The WTRU may determine the mode of operation after cell switch to the target cell based on one or more of the following example options.

In an example, a WTRU that is enabled to operate based on SBFD operation after cell switching to a target cell may determine to use SBFD resources and/or configurations if the measured post cell switching CLI is lower than a first CLI threshold.

For example, a WTRU that is enabled and/or allowed to operate (e.g., perform Tx/Rx) based on a first mode of operation in the target cell and after cell switch may determine to use one or more configured resources and/or configurations for operation based on the first mode of operation. The first mode of operation may be for example based on Tx/Rx based on configured SBFD resources and/or configurations. In an example, the WTRU may be (pre) configured for being enabled and/or allowed to operate based on the first mode of operation, for example via RRC, MAC-CE, and/or DCI signaling.

For example, the WTRU may receive an indication, for example as part of MAC-CE indication to enable SBFD operation, see parameter SBFD 440 as a flag indication, for example, in the MAC-CE LTM cell switch triggering command in FIG. 4. In an example, in case the indication to enable the first mode of operation (e.g., to use SBFD resources and/or configurations) in the target cell is indicating a first value (e.g., value one), the WTRU may determine that the first mode of operation is enabled in the target cell. In another example, in case the indication to enable the first mode of operation in the target cell is indicating a second value (e.g., value zero), the WTRU may determine that the first mode of operation is not enabled in the target cell. As such, the WTRU may use a second mode of operation (e.g., non-SBFD resources and/or configurations).

In an example, in case the WTRU is enabled to operate based on a first mode of operation and in case the WTRU is configured and/or indicated to perform post cell switch CLI measurement, the WTRU may measure one or more L1-CLI values based on one or more configured and/or indicated resources and/or configurations. The WTRU may determine to operate based on the first mode of operation in the target cell and after cell switching if the measured CLI (e.g., L1-CLI) is lower than a corresponding determined, configured and/or indicated first CLI threshold. For example, the WTRU may determine to use configured and/or indicated SBFD resources and/or configurations in the target cell if the measured CLI in the target cell is lower than the first CLI threshold.

In an example, a WTRU that is enabled to operate based on SBFD operation after cell switching to a target cell may determine to operate based on non-SBFD resources and/or configurations if the measured post cell switching CLI is higher than the first CLI threshold.

In an example, a WTRU may be enabled to operate based on the second mode of operation. For example, the WTRU may receive an indication, for example as part of MAC-CE indication to enable or disable first or second modes of operation, for example SBFD or non-SBFD operation, respectively, see parameter SBFD 440 as a flag indication, for example, in the MAC-CE LTM cell switch triggering command in FIG. 4. In another example, the WTRU may receive a separate indication enabling or disabling the second mode of operation (e.g., non-SBFD) as part of the MAC-CE LTM cell switch triggering command. In an example, in case the indication to enable the first mode of operation (e.g., to use SBFD resources and/or configurations) in the target cell is indicating a first value (e.g., value one), the WTRU may determine that the first mode of operation is enabled in the target cell. In another example, in case the indication to enable the first mode of operation in the target cell is indicating a second value (e.g., value zero), the WTRU may determine that the first mode of operation is disabled in the target cell. As such, the WTRU may determine that the second mode of operation (e.g., non-SBFD resources and/or configurations) may be enabled in the target cell.

For example, a WTRU that is enabled and/or allowed to operate (e.g., perform Tx/Rx) based on a second mode of operation in the target cell and after cell switch may determine to use one or more configured resources and/or configurations for operation based on the second mode of operation. In another example, a WTRU that is disabled and/or not allowed to operate (e.g., perform Tx/Rx) based on a first mode of operation in the target cell and after cell switch may determine to use one or more configured resources and/or configurations for operation based on the second mode of operation. The second mode of operation may be for example based on Tx/Rx based on configured non-SBFD resources and/or configurations. In an example, the WTRU may be (pre) configured for being enabled and/or allowed to operate based on the second mode of operation, for example via RRC, MAC-CE, and/or DCI signaling.

In another example, the WTRU may be enabled to operate based on the first mode of operation, where the WTRU may be enabled, configured, and/or indicated to perform post cell switch CLI measurement. As such, the WTRU may measure one or more L1-CLI values based on one or more configured and/or indicated resources and/or configurations. The WTRU may determine to operate based on the second mode of operation in the target cell and after cell switching if the measured CLI (e.g., L1-CLI) is higher than a corresponding determined, configured and/or indicated first CLI threshold. For example, the WTRU may determine to use configured and/or indicated non-SBFD configurations and/or resources in the target cell if the measured CLI in the target cell is higher than the first CLI threshold.

Examples are provided herein of switching back to the previous serving cell. In an example, a WTRU that is enabled to operate based on SBFD operation after cell switching to a target cell may determine to switch back to the previous (e.g., serving) cell if the measured post cell switching CLI is higher than a second CLI threshold and the measured RSRP (before switching) in the previous serving cell is higher than a first RSRP threshold.

For example, in case the WTRU is enabled to operate based on the first mode of operation (e.g., SBFD) and in case the WTRU is enabled, configured, and/or indicated to perform post cell switch CLI measurement, the WTRU may measure one or more L1-CLI values based on one or more configured and/or indicated resources and/or configurations. In an example, the WTRU may be (pre) indicated and/or (pre) configured with an indication to enable switching back to the (previous) serving cell in case the post switching measured CLI is higher than the second CLI threshold, and the measured RSRP from the serving cell is higher than the first RSRP threshold. In an example, the WTRU may measure the L1-CLI in the target cell and after cell switching, where the WTRU may determine that the measured CLI is higher than the second determined, configured, and/or indicated threshold. In another example, the WTRU may measure RSRP in the (previous) serving cell and before switching to the target cell, where the WTRU may determine that the measured RSRP is higher than the determined, configured, and/or indicated first RSRP threshold. As such, the WTRU may determine to switch back to the previous serving cell if the WTRU is enabled to perform the switch back. Herein, RSRP may be used interchangeably with RSSI, SINR, RSRQ, CQI, and the like, and still consistent with this solution.

In an example, the WTRU may be (pre) configured and/or indicated with the indication to enable switching back to the (previous) serving cell via RRC, MAC-CE, DCI, and the like. For example, the WTRU may be (pre) configured with the enable or disable indication as part of configurations and/or indications received from the (previous) serving cell and for example before cell switching. In an example, the WTRU may be (pre) configured with one or more second CLI thresholds, first RSRP thresholds, and/or at least an indication to enable the switch back procedure, e.g., via RRC, MAC-CE, DCI, and the like. For example, the WTRU may be configured and/or indicated with enabling indication to switch back and/or fall back to the previous serving cell as part of LTM cell switching MAC-CE command, e.g., via parameter SW-Prev 460 in FIG. 4. In an example, the second CLI threshold may be similar to or higher than the first CLI threshold. For example, the WTRU may determine the second CLI threshold based on an offset value and according to the first CLI threshold, for example to avoid frequent cell switching and ping-ponging.

Examples are provided herein of switching to a second target cell. In an example, a WTRU that is enabled to operate based on SBFD operation after cell switching to a first target cell may determine to switch to a determined, configured, and/or indicated second cell if the measured post cell switching CLI is higher than a third CLI threshold and the measured RSRP based on the second cell is higher than a second RSRP threshold.

For example, in case the WTRU is enabled to operate based on the first mode of operation (e.g., SBFD) after cell switching to a first target cell and in case the WTRU is enabled, configured, and/or indicated to perform post cell switch CLI measurement, the WTRU may measure one or more L1-CLI values based on one or more configured and/or indicated resources and/or configurations. In an example, the WTRU may be (pre) indicated and/or (pre) configured with an indication to enable switching to a second cell in addition to the second cell's index and/or configuration ID, in case the post switching measured CLI in the first target cell is higher than the third CLI threshold, and the measured RSRP from the second target cell is higher than the second RSRP threshold. In an example, the WTRU may measure the L1-CLI in the first target cell and after cell switching, where the WTRU may determine that the measured CLI is higher than the third determined, configured, and/or indicated threshold. In another example, the WTRU may measure RSRP in the second target cell, where the WTRU may determine that the measured RSRP is higher than the determined, configured, and/or indicated second RSRP threshold. As such, the WTRU may determine to switch to the configured and/or indicated second target cell if the WTRU is enabled to perform the second cell switching.

In an example, the WTRU may determine, be configured, and/or indicated to use the RSRP that was (previously) measured before first cell switching to the first target cell to determine if the measured RSRP is high or lower than the second RSRP threshold. In another example, the WTRU may determine, be configured, and/or indicated with one or more resources and/or configurations to be used for RSRP measurement in the second target cell, for example after first cell switching to the first target cell. For example, the configurations for RSRP measurement in the second target cell may include time and frequency resources, periodicity, CSI-RS resources, CSI-RS resource sets, SSB index, TCI state, and the like.

In an example, the WTRU may be (pre) configured and/or indicated with the indication to enable switching to the second target cell via RRC, MAC-CE, DCI, etc. For example, the WTRU may be configured and/or indicated with the enable or disable indication as part of configurations and/or indications received from the (previous) serving cell and for example before cell switching. In another example, the WTRU may be configured and/or indicated with the configuration ID or cell ID corresponding to the second target cell, for example via RRC, MAC-CE, DCI signaling. In an example, the WTRU may be configured and/or indicated with one or more third CLI thresholds, second RSRP thresholds, etc., for example via RRC, MAC-CE, DCI, etc. For example, the WTRU may be configured and/or indicated with enabling indication to switch to the second target cell as part of LTM cell switching MAC-CE command, e.g., via parameter SW-Next 470 in FIG. 4. In an example, the WTRU may be configured and/or indicated with second target cell's configuration ID and/or cell ID as part of LTM cell switching MAC-CE command, e.g., via parameter SW-TargetID 490 in FIG. 4. In an example, the second RSRP threshold may be similar or different from the first RSRP threshold. In another example, the third CLI threshold may be similar or higher than the first and second CLI thresholds. For example, the WTRU may determine the second RSRP threshold based on an offset value and according to the first RSRP threshold, for example to avoid frequent cell switching and ping-ponging. In another example, the WTRU may determine the third CLI threshold based on one or more offset values and according to the first or second CLI thresholds, for example to avoid frequent cell switching and ping-ponging.

Examples provided herein include further actions based on the determined mode of operation. In an example, in case the WTRU determines to switch back to the serving cell, the WTRU may send a notification signal (e.g., an SR) to the serving cell to indicate the switching back to the serving cell. In another example, the WTRU may send an indication based on a (pre) configured UL grant to the serving cell to indicate the switching back. For example, the WTRU may be (pre) configured with the configured grant as part of LTM cell switching configurations and/or indications, for example via RRC, MAC-CE, DCI, etc. signaling. In an example, the WTRU may receive a cell switching command (e.g., LTM cell switching MAC-CE command) that comprises information on the (pre) configured UL grant (e.g., configuration on the notification signal). Based on receiving the cell switching command, the WTRU may determine (e.g., identify) how and/or when to transmit the notification signal. Based on the determination, the WTRU may transmit the notification signal, which may provide benefits in that the network may ensure that the WTRU has switched back to the serving cell.

In an example, in case the WTRU determines to switch to the second target cell, the WTRU may send a PRACH to the second target cell, e.g., in case of RACH-based cell switching. In another example, in case of RACH-less cell switching, the WTRU may send a notification signal (e.g., an SR) to the second target cell. In another example, the WTRU may send an indication based on a (pre) configured UL grant to the second target cell to indicate the switching to the second cell. For example, the WTRU may be (pre) configured with the configured grant as part of cell switching configurations and/or indications, for example via RRC, MAC-CE, DCI, etc. signaling. In another example, the WTRU may be configured and/or indicated to perform RACH-less or RACH-based cell switching to the second target cell. For example, the WTRU may be configured and/or indicated with CFRA configurations with regards to the second target cell, for example in case of RACH-based cell switching, as described herein. In an example, the WTRU may receive a cell switching command (e.g., LTM cell switching MAC-CE command) that comprises information on the (pre) configured UL grant (e.g., configuration on the notification signal) and/or the CFRA configurations with respect to the second target cell. Based on receiving the cell switching command, the WTRU may determine (e.g., identify) how and/or when to transmit the notification signal and/or how/when to transmit PRACH based on the CFRA configurations toward the second target cell. In another example, the WTRU may be configured and/or indicated with timing advance to be used for UL transmission in the second target cell, for example in case of RACH-less cell switching, as described herein.

In an example, a WTRU may transmit one or more reports and/or indications to indicate the measured CLI. The WTRU may use the configured reporting resources, where the resources may be received as part of (e.g., RRC) (pre) configured configurations for a respective cell. For example, the configured reporting resources may be based on a configured UL grant, one or more SR transmission occasions, and so forth. In an example, in case the WTRU switches and/or HO to a first target cell, the WTRU may use the reporting resources that may have been configured (e.g., via RRC) as part of first cell's (pre) configurations. In another example, in case the WTRU switches back to the serving cell, the WTRU may use the reporting resources that may have been configured (e.g., via RRC) as part of switching back (pre) configurations. In another example, in case the WTRU switches to a second target cell, the WTRU may use the reporting resources that may have been configured (e.g., via RRC) as part of second cell's (pre) configurations, and so forth. For example, the WTRU may transmit the report to a gNB or base station. In an example, the WTRU may send the report and/or indications via uplink control information (UCI), MAC-CE, and/or RRC signaling.

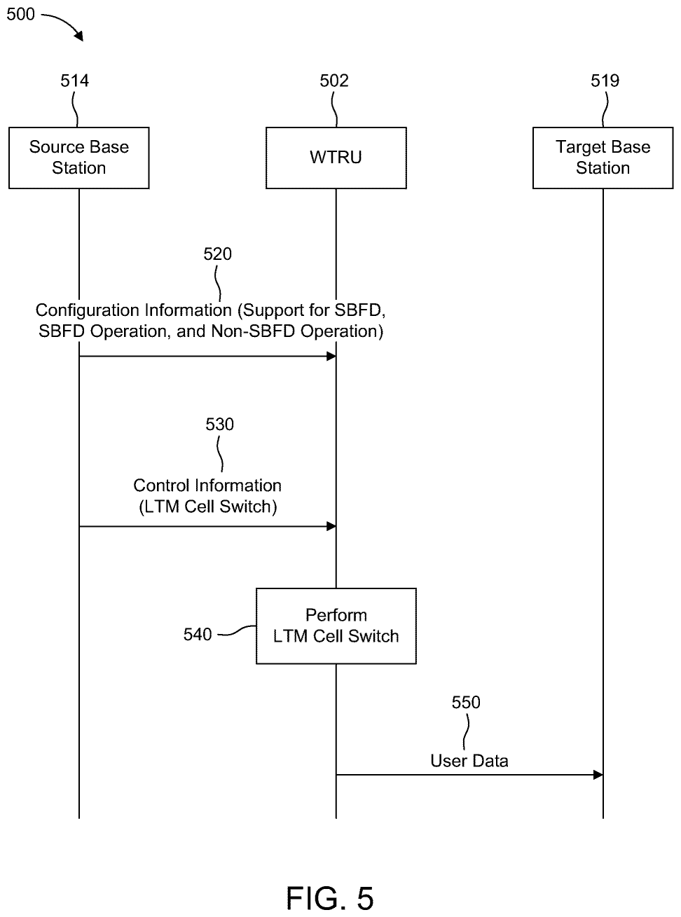

FIG. 5 is a signaling diagram illustrating an example of an SBFD configuration in LTM. As shown in an example in signaling diagram 500, a base station 514, such as a source base station, transmits configuration information 520 to a WTRU 502. In an example, the base station 514 may be a gNB. Additionally or alternatively, the base station 514 may be the same as or similar to base station 114a. Additionally or alternatively, the WTRU 502 may be the same as or similar to WTRU 102. The WTRU 502 receives the configuration information 520 from the source base station 514. Further, the configuration information 520 includes information indicating support for SBFD operation. Also, the configuration information 520 includes information for SBFD operation. Additionally or alternatively, the configuration information 520 may include information for non-SBFD operation.

Further, the base station 514 transmits to the WTRU 502 control information 530 regarding an LTM cell switch. Accordingly, the WTRU receives the control information. The control information 530 further includes CLI measurement information, in an example.

The WTRU 502 then performs LTM cell switch 540 to a first target base station, such as target base station 519. Additionally or alternatively, the target base station 519 may be the same as or similar to base station 114b. In an example, the target base station 519 may be a gNB.

Additionally or alternatively, the WTRU 502 measures CLI based on the received CLI measurement information. Moreover, if the measured CLI is lower than a first CLI threshold, the WTRU 502 transmits user data 550 to the first target base station 519 using, based on the information for SBFD operation, SBFD operation.

Additionally or alternatively, if the measured CLI is equal to or higher than a first CLI threshold, the WTRU 502 transmits user data to the first target base station 519 using, based on the information for non-SBFD operation, non-SBFD operation. Additionally or alternatively, the information for SBFD operation includes a UL grant, an RA configuration, and one or more PDCCH monitoring occasions. Further, the SBFD operation applies to SBFD time units. Additionally or alternatively, the information for non-SBFD operation includes a UL grant, an RA configuration, and one or more PDCCH monitoring occasions. Moreover, the non-SBFD operation applies to non-SBFD time units.

Additionally or alternatively, the control information 530 regarding an LTM cell switch further includes indication information to enable SBFD operation. Additionally or alternatively, the WTRU 502 transmits the user data to the target base station 519 using, further based on the indication information to enable SBFD operation, SBFD operation. Additionally or alternatively, the user data is transmitted to the target base station 519 using, further based on a symbol type in which the control information regarding an LTM cell switch is received, SBFD operation.

Additionally or alternatively, the WTRU 502 performs an LTM cell switch to the source base station 514 on a condition that the measured CLI is equal to or higher than a second CLI threshold. Additionally or alternatively, the WTRU 502 performs an LTM cell switch to a second target base station on a condition that the measured CLI is equal to or higher than a third CLI threshold. In an example, the second target base station may be a gNB.

Additionally or alternatively, the WTRU 502 reports the measured CLI. Additionally or alternatively, the WTRU 502 reports the measured CLI to the first target base station 519. Additionally or alternatively, the WTRU 502 reports the measured CLI to the source base station 514. Additionally or alternatively, the WTRU 502 reports the measured CLI to the second target base station. Additionally or alternatively, the first CLI threshold is received in at least one of a MAC-CE, RRC signaling, or DCI.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving, from a source base station, configuration information including:
information indicating support for subband non-overlapping full duplex (SBFD) operation,
information for SBFD operation, and
information for non-SBFD operation;
receiving, from the source base station, control information regarding a layer 1 (L1)/layer 2 (L2) triggered mobility (LTM) cell switch, including cross-link interference (CLI) measurement information;
performing the LTM cell switch to a first target base station;
measuring CLI based on the received CLI measurement information; and
transmitting, on a condition that the measured CLI is lower than a first CLI threshold, user data to the first target base station using, based on the information for SBFD operation, SBFD operation.

2. The method of claim 1, further comprising:
transmitting, on a condition that the measured CLI is equal to or higher than a first CLI threshold, user data to the first target base station using, based on the information for non-SBFD operation, non-SBFD operation.

3. The method of claim 1, wherein the information for SBFD operation includes an uplink (UL) grant, a random access (RA) configuration, and one or more physical downlink control channel (PDCCH) monitoring occasions, wherein the SBFD operation applies to SBFD time units; and wherein the information for non-SBFD operation includes a UL grant, an RA configuration, and one or more PDCCH monitoring occasions, wherein the non-SBFD operation applies to non-SBFD time units.

4. The method of claim 1, wherein the control information regarding an LTM cell switch further includes indication information to enable SBFD operation.

5. The method of claim 4, wherein the user data is transmitted to the target base station using, further based on the indication information to enable SBFD operation, SBFD operation.

6. The method of claim 1, wherein the user data is transmitted to the target base station using, further based on a symbol type in which the control information regarding an LTM cell switch is received, SBFD operation.

7. The method of claim 1, further comprising:
performing an LTM cell switch to the source base station on a condition that the measured CLI is equal to or higher than a second CLI threshold.

8. The method of claim 1, further comprising:
performing an LTM cell switch to a second target base station on a condition that the measured CLI is equal to or higher than a third CLI threshold.

9. The method of claim 1, further comprising:
reporting the measured CLI.

10. The method of claim 1, where the first CLI threshold is received in at least one of a medium access control (MAC) control element (CE), radio resource control (RRC) signaling, or downlink control information (DCI).

11. A wireless transmit/receive unit (WTRU) comprising:
a transceiver; and
a processor, operatively coupled to the transceiver; wherein:
the transceiver is configured to receive, from a source base station, configuration information including:
information indicating support for subband non-overlapping full duplex (SBFD) operation,
information for SBFD operation, and
information for non-SBFD operation;
the transceiver is configured to receive, from the source base station, control information regarding a layer 1 (L1)/layer 2 (L2) triggered mobility (LTM) cell switch, including cross-link interference (CLI) measurement information;
the processor and transceiver are configured to perform an LTM cell switch to a first target base station;
the processor and transceiver are configured to measure CLI based on the received CLI measurement information;
the processor and transceiver are configured to transmit, on a condition that the measured CLI is lower than a first CLI threshold, user data to the first target base station using, based on the information for SBFD operation, SBFD operation.

12. The WTRU of claim 11, wherein the processor and transceiver are further configured to transmit, on a condition that the measured CLI is equal to or higher than a first CLI threshold, user data to the first target base station using, based on the information for non-SBFD operation, non-SBFD operation.

13. The WTRU of claim 11, wherein the information for SBFD operation includes an uplink (UL) grant, a random access (RA) configuration, and one or more physical downlink control channel (PDCCH) monitoring occasions, wherein the SBFD operation applies to SBFD time units; and wherein the information for non-SBFD operation includes a UL grant, an RA configuration, and one or more PDCCH monitoring occasions, wherein the non-SBFD operation applies to non-SBFD time units.

14. The WTRU of claim 11, wherein the control information regarding an LTM cell switch further includes indication information to enable SBFD operation.

15. The WTRU of claim 14, wherein the user data is transmitted to the target base station using, further based on the indication information to enable SBFD operation, SBFD operation.

16. The WTRU of claim 11, wherein the user data is transmitted to the target base station using, further based on a symbol type in which the control information regarding an LTM cell switch is received, SBFD operation.

17. The WTRU of claim 11, wherein the processor and transceiver are further configured to perform an LTM cell switch to the source base station on a condition that the measured CLI is equal to or higher than a second CLI threshold.

18. The WTRU of claim 11, wherein the processor and transceiver are further configured to perform an LTM cell switch to a second target base station on a condition that the measured CLI is equal to or higher than a third CLI threshold.

19. The WTRU of claim 11, wherein the processor and transceiver are further configured to report the measured CLI.

20. The WTRU of claim 11, where the first CLI threshold is received in at least one of a medium access control (MAC) control element (CE), radio resource control (RRC) signaling, or downlink control information (DCI).
